(19) United States
(12) Patent Application Publication
(10) Pub. No.: US 2024/0265240 A1
(43) Pub. Date: Aug. 8, 2024

(54) METHOD, APPARATUS AND COMPUTER PROGRAM PRODUCT FOR DEFINING IMPORTANCE MASK AND IMPORTANCE ORDERING LIST

(71) Applicant: Nokia Technologies Oy, Espoo (FI)

(72) Inventors: Honglei ZHANG, Tampere (FI); Francesco CRICRÌ, Tampere (FI); Ramin GHAZNAVI YOUVALARI, Tampere (FI); Hamed REZAZADEGAN TAVAKOLI, Espoo (FI); Nannan ZOU, Tampere (FI); Vinod Kumar MALAMAL VADAKITAL, Tampere (FI); Miska Matias HANNUKSELA, Tampere (FI); Yat Hong LAM, Tampere (FI); Jani LAINEMA, Tampere (FI); Emre Baris AKSU, Tampere (FI)

(21) Appl. No.: 18/567,736

(22) PCT Filed: Jun. 17, 2022
(86) PCT No.: PCT/IB2022/055623

§ 371 Date: Dec. 6, 2023

Related U.S. Application Data
(60) Provisional application No. 63/202,680, filed on Jun. 21, 2021.

(51) Int. Cl. G06N 3/0455

(52) U.S. Cl. CPC G06N 3/0455

(57) ABSTRACT

An example apparatus includes at least one processor; and at least one non-transitory memory comprising computer program code; wherein the at least one memory and the computer program code are configured to, with the at least one processor, cause the apparatus at least to perform; learn importance of one or more parameters by using a training dataset; define one or more masks for indicating the importance of the one or more parameters for a model finetuning; share at least one mask of the one or more masks with at least one of an encoder or a decoder; finetune at least one parameter of the one or more parameters based at least on the at least one mask; send or signal one or more weight updates corresponding to the at least one parameter in a bitstream to the decoder.

### SUPPORT STATEMENT

The project leading to this application has received funding from the ECSEL Joint Undertaking (JU) under grant agreement No 783162. The JU receives support from the European Union's Horizon 2020 research and innovation programme and Netherlands, Czech Republic, Finland, Spain, Italy.

The project leading to this application has received funding from the ECSEL Joint Undertaking (JU) under grant agreement No 876019. The JU receives support from the European Union's Horizon 2020 research and innovation programme and Germany, Netherlands, Austria, Romania, France, Sweden, Cyprus, Greece, Lithuania, Portugal, Italy, Finland, Turkey.

### TECHNICAL FIELD

The examples and non-limiting embodiments relate generally to multimedia transport and neural networks, and more particularly, to method, apparatus, and computer program product for defining at least one of one or more masks or one or more ordering lists.

### BACKGROUND

It is known to provide standardized formats for exchange of neural networks.

### SUMMARY

An example apparatus includes at least one processor; and at least one non-transitory memory comprising computer program code; wherein the at least one memory and the computer program code are configured to, with the at least one processor, cause the apparatus at least to perform: learn importance of one or more parameters by using a training dataset; define one or more masks for indicating the importance of the one or more parameters for a model finetuning; share at least one mask of the one or more masks with at least one of an encoder or a decoder; finetune at least one parameter of the one or more parameters based at least on the at least one mask; send or signal one or more weight updates corresponding to the at least one parameter in a bitstream to the decoder.

The example apparatus may further include, wherein the apparatus is further caused to: learn an ordering of the importance of the one or more parameters in the decoder by using the training dataset; define one or more ordering lists for indicating the ordering of the importance of the one or more parameters; share at least one ordering list of the one or more ordering lists with at least one of the encoder or the decoder; and send or signal at least one parameter of the one or more parameter that are updated by the model finetuning and at least one weight update corresponding to the at least one parameter to the decoder, wherein the decoder recovers the at least one weight update from the bitstream by using the received at least one parameter and the at least one ordering list.

The example apparatus may further include, wherein the apparatus is further caused to determine at least one of: the at least one mask of the one or more masks to be used by the encoder during the model finetuning; or at least one ordering list of the one or more ordering lists to be used by the encoder during the model finetuning stage.

The example apparatus may further include, wherein the one or more masks comprise one or more binary masks that indicate the one or more parameters from fine-tunable parameters.

The example apparatus may further include, wherein the one or more ordering lists indicate the ordering of importance of each fine-tunable parameter.

The example apparatus may further include, wherein to learn importance of the one or more parameters or to learn an ordering of the importance of the one or more parameters, the apparatus is further caused to: minimize an objective function with a suitable loss term; determine one or more importance scores for each parameter based on the minimized objective function; and determine at least one of: the at least one mask by using the one or more importance scores and a threshold value; or the at least one ordering list by sorting the one or more parameters based on the one or more importance scores of the each one or more parameters.

The example apparatus may further include, wherein the objective function is minimized by using an optimization function.

The example apparatus may further include, wherein the one or more importance scores for the each parameter comprises one of: a sum of an absolute value of the weight update value of the each parameter for samples in the training dataset; a sum of an absolute value of a ratio of the weight update value over the original weight value on the each parameter for samples in the training dataset; a combination of an importance metric and a learned importance, wherein the combination is using a summation or multiplication of scores of the one or more parameters; or a non-linear combination of an importance metric and a learned importance, wherein the non-linear combination is determined using a learning based approach.

The example apparatus may further include, wherein the one or more importance scores for the each parameter is determined using one of: an importance metric comprising at least one of: a sum of absolute values; graph diffusion-based approaches; or saliency techniques; an amount of change in a gradient and a hessian change during training process; or a specific metric determination process by external processing system.

The example apparatus may further include, wherein the apparatus is further caused to identify an optimal number of the one or more parameters and the corresponding weight updates, and wherein to identify the optimal number of the one or more important parameters and the corresponding weight updates, the apparatus is further caused to: perform a first model finetuning by selecting a large number of important parameters based on the one or more ordering lists; save the first finetuned model to achieve the first saved finetuned model; calculate a first rate distortion (RD) loss value including the weight update overheads; and repeat following until a stopping criterion is met: remove a predetermined number of least important parameters from the one or more important parameters; continue the model finetuning from the first saved finetuned model to achieve a second finetuned model; save the second finetuned model; and calculate a second RD loss value including the weight update overheads.

The example apparatus may further include, wherein the stopping criterion comprises determining best performance or a number of selected parameters reaches a threshold value.

The example apparatus may further include, wherein the apparatus is further caused to identify an optimal number of the one or more parameters and the corresponding weight updates, and wherein to identify optimal number of the one or more important parameters and the corresponding weight updates, the apparatus is further caused to apply the golden-section search technique.

The example apparatus may further include, wherein the apparatus is further caused to divide the training dataset into multiple subsets and each subset is used to learn the at least one mask of the one or more masks or the at least one ordering list of the one or more ordering lists, and wherein the training dataset is divided according to a similarity of a content, or the similarity of the one or more important parameters according to a pre-trained model.

The example apparatus may further include, wherein the apparatus is further caused to compress and quantize the at least one parameter, and wherein the decoder decompresses and dequantizes the compressed and quantized at least one parameters.

The example apparatus may further include, wherein the apparatus is further caused to: determine an optimal mask of the one or more masks; determine optimal weight updates corresponding to the optimal mask at the model finetuning stage; and send or signal an index of the optimal mask and the optimal weight updates corresponding to the optimal mask to the decoder, wherein the decoder reconstructs an index of the optimal mask and the optimal weight updates from the bitstream and updates the parameters corresponding to the optimal weight updates in the model according to the optimal mask.

The example apparatus may further include, wherein the apparatus is further caused to: determine an optimal ordering list from the one or more ordering lists; determine an optimal number of parameters from the one or more parameters; determine an optimal number of weight updates corresponding to the optimal parameters at the model finetuning stage; send or signal an index of the optimal ordering list, the optimal number of parameters, and the optimal weight updates to the decoder, wherein the decoder reconstructs the index of the optimal ordering list, the optimal number of parameters, and the optimal weight updates from the bitstream, and updates the parameters corresponding to the optimal weight updates in the model according to the optimal ordering list and the optimal number of parameters.

The example apparatus may further include, wherein the apparatus is further caused to at least compress or quantize the optimal weight updates.

The example apparatus may further include, wherein the apparatus is further caused to: learn the one or more masks or the one or more ordering lists from an input content; and signal the learned one or more masks or ordering lists to the decoder.

The example apparatus may further include, wherein to share the at least one mask and the at least one ordering lists, the apparatus is further caused to perform one or more of: define at least one of the one or more masks or the one or more ordering list; define a unique identifier for each mask or each ordering list, and indicate the unique identifiers of the each mask or the each ordering list in or along the bitstream from the encoder to the decoder; deliver the at least one of the at least one mask or the at least one ordering list in or along the bitstream; deliver the at least one of the at least one mask or the at least one ordering list; or deliver the at least one of the at least one mask or the at least one ordering lists from the encoder to the decoder prior to or during bitstream delivery.

The example apparatus may further include, wherein the apparatus is further caused to: select a first number of parameters to be updated for a first unit of the bitstream; indicate the first number of parameters and the updated first number of parameters associated with the first unit of the bitstream; use an updated neural network for encoding the first unit of the bitstream; select a second number of parameters to be updated for a second unit of the bitstream, wherein the second unit follows the first unit in the bitstream order, and the second number of parameters follow the first number of parameters in the at least one ordering list; indicate the second number of parameters and the updated second number of parameters associated with the second unit of the bitstream; use the updated neural network for encoding the second unit of the bitstream.

The example apparatus may further include, wherein the apparatus is further caused to select at least one of the first number of parameters or the second number of parameters according to one or more of the following: a bit budget for updated first number of parameters or the updated second number of parameter; or a rate-distortion decision performed for the first unit and first number of parameters separately from the second unit and second number of parameters, wherein the first unit and the second unit may are selected to be a first coded picture and a second coded picture respectively, or a first hierarchical prediction structure of pictures and a second hierarchical prediction structure of the pictures.

The example apparatus may further include, wherein the bit budget is determined based on one or more of the following: a leftover bitrate in a previous unit the bitstream; or a leftover size in video packets; wherein in a packet-oriented networks one or more packets up to the maximum transfer unit (MTU) size are treated equally, and wherein the bit budget is be determined to fill in a packet up to an MTU size in an instance a unit of the bitstream carried in the packet has size less than the MTU size.

The example apparatus may further include, wherein the apparatus is further caused to determine and indicate in or along the bitstream: whether the second number of parameters follow the first number of parameters in the at least one ordering list; or whether second number of parameters are related to a start of the at least one ordering list; wherein the decoder decodes associated weight updates according to the indicated position in the at least one ordering list.

The example apparatus may further include, wherein the number of the one or more parameters comprises an integer.

The example apparatus may further include, wherein the decoder reconstructs the one or more weight updates from the bitstream and updates one or more parameters corresponding to the one or more weight updates based on the at least one mask.

Another example apparatus includes at least one processor; and at least one non-transitory memory comprising computer program code; wherein the at least one memory and the computer program code are configured to, with the at least one processor, cause the apparatus at least to perform: receive one or more weight updates corresponding to at least one parameter in a bitstream; reconstruct the at least one weight update from the bitstream; and update corresponding at least one parameter based on at least one mask; wherein importance of the at least one parameter is learnt by using a training dataset; and wherein one or more masks are defined for indicating importance of one or more parameters for a model finetuning; and wherein the at least one mask is shared by an encoder and a decoder.

The example apparatus may further include, wherein the apparatus is further caused to: receive a number of one or more parameters that are updated at the model finetuning and one or more corresponding weight updates; recover one or more weight updates from a bitstream by using the received number of the one or more parameters and one or more ordering lists; wherein an ordering of importance of the one or more parameters in the decoder is learnt by using the training dataset; and wherein the one or more ordering lists indicate the ordering of the importance of the one or more parameters; and wherein the one or more importance ordering list is shared by the encoder and the decoder.

The example apparatus may further include, wherein the apparatus is further caused to: reconstruct a first number of parameters and a respective first number of weight updates from the bitstream; update the corresponding first number of parameters in the model according to the one or more importance ordering list; use an updated neural network for decoding a first unit of the bitstream; reconstruct a second number of parameters and a respective second number of weight updates from the bitstream, wherein the second unit follows the first unit in the bitstream order, and the second number of parameters follow the first number of parameters in the importance ordering list; update the corresponding second number parameters in the model according to the one or more importance ordering list; and use the updated neural network for decoding a second unit of the bitstream.

An example method includes: learning importance of one or more parameters by using a training dataset; defining one or more masks for indicating the importance of the one or more parameters for a model finetuning; sharing at least one mask of the one or more masks with at least one of an encoder or a decoder; finetuning at least one parameter of the one or more parameters based at least on the at least one mask; sending or signaling one or more weight updates corresponding to the at least one parameter in a bitstream to the decoder.

The example method may further include: learning an ordering of the importance of the one or more parameters in the decoder by using the training dataset; defining one or more ordering lists for indicating the ordering of the importance of the one or more parameters; sharing at least one ordering list of the one or more ordering lists with at least one of the encoder or the decoder; and sending or signaling at least one parameter of the one or more parameter that are updated by the model finetuning and at least one weight update corresponding to the at least one parameter to the decoder, wherein the decoder recovers the at least one weight update from the bitstream by using the received at least one parameter and the at least one ordering list.

Another example method includes: receiving one or more weight updates corresponding to at least one parameter in a bitstream; reconstructing the at least one weight update from the bitstream; and updating corresponding at least one parameter based on at least one mask; wherein importance of the at least one parameter is learnt by using a training dataset; and wherein one or more masks are defined for indicating importance of one or more parameters for a model finetuning; and wherein the at least one mask is shared by an encoder and a decoder.

The example method may further include: receiving a number of one or more parameters that are updated at the model finetuning and one or more corresponding weight updates; recovering one or more weight updates from a bitstream by using the received number of the one or more parameters and one or more ordering lists; wherein an ordering of importance of the one or more parameters in the decoder is learnt by using the training dataset; and wherein the one or more ordering lists indicate the ordering of the importance of the one or more parameters; and wherein the one or more importance ordering list is shared by the encoder and the decoder.

Yet another example apparatus includes at least one processor; and at least one non-transitory memory comprising computer program code; wherein the at least one memory and the computer program code are configured to, with the at least one processor, cause the apparatus at least to perform: learn an ordering of importance of one or more parameters in a decoder by using a training dataset; define one or more ordering lists for indicating the ordering of the importance of the one or more parameters; share the one or more ordering list with an encoder and a decoder; send or signal a number of the one or more parameters that are updated at a model finetuning and one or more corresponding weight updates to the decoder.

The example apparatus may further include, wherein the decoder recovers the one or more weight updates from a bitstream by using the received number of the one or more parameters and the one or more weight ordering lists.

Yet another example method includes: learning an ordering of importance of one or more parameters in a decoder by using a training dataset; defining one or more ordering lists for indicating the ordering of the importance of the one or more parameters; sharing the one or more ordering list with an encoder and a decoder; sending or signaling a number of the one or more parameters that are updated at a model finetuning and one or more corresponding weight updates to the decoder.

The example method may further include, wherein the decoder recovers the one or more weight updates from a bitstream by using the received number of the one or more parameters and the one or more weight ordering lists.

An example computer readable medium includes program instructions for causing an apparatus to perform methods as described in any of the previous paragraphs.

The example computer readable medium of claim may include, wherein the computer readable medium comprises a non-transitory computer readable medium.

### BRIEF DESCRIPTION OF THE DRAWINGS

The foregoing aspects and other features are explained in the following description, taken in connection with the accompanying drawings, wherein:

FIG. 1 shows schematically an electronic device employing embodiments of the examples described herein.

FIG. 2 shows schematically a user equipment suitable for employing embodiments of the examples described herein.

FIG. 3 further shows schematically electronic devices employing embodiments of the examples described herein connected using wireless and wired network connections.

FIG. 4 shows schematically a block diagram of an encoder on a general level.

FIG. 5 is a block diagram showing an interface between an encoder and a decoder in accordance with the examples described herein.

FIG. 6 illustrates a system configured to support streaming of media data from a source to a client device;

FIG. 7 is a block diagram of an apparatus that may be specifically configured in accordance with an example embodiment.

FIG. 8 illustrates examples of functioning of neural networks (NNs) as components of a traditional codec's pipeline, in accordance with an example embodiment.

FIG. 9 illustrates an example of modified video coding pipeline based on neural network, in accordance with an example embodiment.

FIG. 10 is an example neural network-based end-to-end learned video coding system, in accordance with an example embodiment.

FIG. 11 illustrates a pipeline of video coding for machines (VCM), in accordance with an embodiment.

FIG. 12 illustrates an example of an end-to-end learned approach for the use case of video coding for machines, in accordance with an embodiment.

FIG. 13 illustrates an example of how the end-to-end learned system may be trained for the use case of video coding for machines, in accordance with an embodiment.

FIG. 14 is an example apparatus, which may be implemented in hardware, configured to implement mechanisms for defining at least one of one or more masks or one or more ordering lists, based on the examples described herein.

FIG. 15 illustrates an example method for defining one or more masks, in accordance with an embodiment.

FIG. 16 illustrates an example method for defining one or more ordering lists, in accordance with an embodiment.

FIG. 17 is an example apparatus, which may be implemented in hardware, configured to implement mechanisms for updating one or more parameters based on at least one of one or more importance masks or one or more ordering lists, in accordance with an examples described herein.

FIG. 18 illustrates an example method for defining one or more ordering lists, in accordance with an embodiment.

FIG. 19 is a block diagram of one possible and non-limiting system in which the example embodiments may be practiced.

### DETAILED DESCRIPTION OF EXAMPLE EMBODIMENTS

The following acronyms and abbreviations that may be found in the specification and/or the drawing figures are defined as follows:
3GP 3GPP file format
3GPP 3rd Generation Partnership Project
3GPP TS 3GPP technical specification
4CC four character code
4G fourth generation of broadband cellular network technology
5G fifth generation cellular network technology
5GC 5G core network
ACC accuracy
AI artificial intelligence
AIoT AI-enabled IoT
ALF adaptive loop filtering
a.k.a. also known as
AMF access and mobility management function
APS adaptation parameter set
AVC advanced video coding
bpp bits-per-pixel
CABAC context-adaptive binary arithmetic coding
CDMA code-division multiple access
CE core experiment
ctu coding tree unit
CU central unit
DASH dynamic adaptive streaming over HTTP
DCT discrete cosine transform
DSP digital signal processor
DU distributed unit
eNB (or eNodeB) evolved Node B (for example, an LTE base station)
EN-DC E-UTRA-NR dual connectivity
en-gNB or En-gNB node providing NR user plane and control plane protocol terminations towards the UE, and acting as secondary node in EN-DC
E-UTRA evolved universal terrestrial radio access, for example, the LTE radio access technology
FDMA frequency division multiple access
f(n) fixed-pattern bit string using n bits written (from left to right) with the left bit first.
F1 or F1-C interface between CU and DU control interface
gNB (or gNodeB) base station for 5G/NR, for example, a node providing NR user plane and control plane protocol terminations towards the UE, and connected via the NG interface to the 5GC
GSM Global System for Mobile communications
H.222.0 MPEG-2 Systems is formally known as ISO/IEC 13818-1 and as ITU-T Rec. H.222.0
H.26x family of video coding standards in the domain of the ITU-T
HLS high level syntax
IBC intra block copy
ID identifier
IEC International Electrotechnical Commission
IEEE Institute of Electrical and Electronics Engineers
I/F interface
IMD integrated messaging device
IMS instant messaging service
IoT internet of things
IP internet protocol
IRAP intra random access point
ISO International Organization for Standardization
ISOBMFF ISO base media file format
ITU International Telecommunication Union
ITU-T ITU Telecommunication Standardization Sector
JPEG joint photographic experts group
LMCS luma mapping with chroma scaling
LTE long-term evolution
LZMA Lempel-Ziv-Markov chain compression
LZMA2 simple container format that can include both uncompressed data and LZMA data
LZO Lempel-Ziv-Oberhumer compression
LZW Lempel-Ziv-Welch compression
MAC medium access control
mdat MediaDataBox
MME mobility management entity
MMS multimedia messaging service
moov MovieBox
MP4 file format for MPEG-4 Part 14 files
MPEG moving picture experts group
MPEG-2 H.222/H.262 as defined by the ITU
MPEG-4 audio and video coding standard for ISO/IEC 14496
MSB most significant bit
NAL network abstraction layer
NDU NN compressed data unit
ng or NG new generation
ng-eNB or NG-eNB new generation eNB
NN neural network
NNEF neural network exchange format
NNR neural network representation
NR new radio (5G radio)
N/W or NW network
ONNX Open Neural Network exchange
PB protocol buffers
PC personal computer
PDA personal digital assistant
PDCP packet data convergence protocol
PHY physical layer
packet identifier PID
PLC power line communication
PNG portable network graphics
PSNR peak signal-to-noise ratio
RAM random access memory
RAN radio access network
RBSP raw byte sequence payload
RD loss rate distortion loss
RFC request for comments
RFID radio frequency identification
RLC radio link control
RRC radio resource control
RRH remote radio head
RU radio unit
Rx receiver
SDAP service data adaptation protocol
SGD Stochastic Gradient Descent
SGW serving gateway
SMF session management function
SMS short messaging service
SPS sequence parameter set
st(v) null-terminated string encoded as UTF-8 characters as specified in ISO/IEC 10646
SVC scalable video coding
S1 interface between eNodeBs and the EPC
TCP-IP transmission control protocol-internet protocol
TDMA time divisional multiple access
trak TrackBox
TS transport stream
TUC technology under consideration
TV television
Tx transmitter
UE user equipment
ue(v) unsigned integer Exp-Golomb-coded syntax element with the left bit first
UICC Universal Integrated Circuit Card
UMTS Universal Mobile Telecommunications System
u(n) unsigned integer using n bits
UPF user plane function
URI uniform resource identifier
URL uniform resource locator
UTF-8 8-bit Unicode Transformation Format
VPS video parameter set
WLAN wireless local area network
X2 interconnecting interface between two eNodeBs in LTE network
Xn interface between two NG-RAN nodes

Some embodiments will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms ‘data,’ ‘content,’ ‘information,’ and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even when the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a ‘computer-readable storage medium,’ which refers to a non-transitory physical storage medium (e.g., volatile or non-volatile memory device), can be differentiated from a ‘computer-readable transmission medium,’ which refers to an electromagnetic signal.

A method, apparatus and computer program product are provided in accordance with example embodiments for implementing mechanisms for defining at least one of one or more importance masks or one or more ordering lists. A method, apparatus and computer program product are provided in accordance with another example embodiments for implementing mechanisms for updating one or more parameters based on at least one of one or more importance masks or one or more ordering lists.

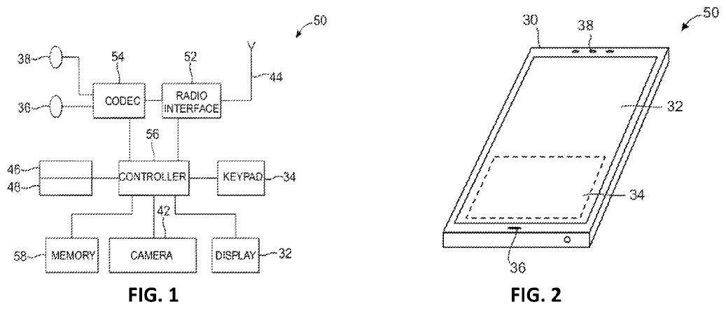

In an example, the following describes in detail suitable apparatus and possible mechanisms for defining at least one of one or more masks or one or more ordering lists. In another example, the following describes in detail suitable apparatus and possible mechanisms for updating one or more parameters based on at least one of one or more masks or one or more ordering lists. In this regard reference is first made to FIG. 1 and FIG. 2, where FIG. 1 shows an example block diagram of an apparatus 50. The apparatus may be an Internet of Things (IoT) apparatus configured to perform various functions, for example, gathering information by one or more sensors, receiving or transmitting information, analyzing information gathered or received by the apparatus, or the like. The apparatus may comprise a video coding system, which may incorporate a codec. FIG. 2 shows a layout of an apparatus according to an example embodiment. The elements of FIG. 1 and FIG. 2 will be explained next.

The apparatus 50 may, for example, be a mobile terminal or user equipment of a wireless communication system, a sensor device, a tag, or a lower power device. However, it would be appreciated that embodiments of the examples described herein may be implemented within any electronic device or apparatus which may process data by neural networks.

The apparatus 50 may comprise a housing 30 for incorporating and protecting the device. The apparatus 50 may further comprise a display 32 in the form of, for example, a liquid crystal display, light emitting diode display, organic light emitting diode display, and the like. In other embodiments of the examples described herein the display may be any suitable display technology suitable to display media or multimedia content, for example, an image or a video. The apparatus 50 may further comprise a keypad 34. In other embodiments of the examples described herein any suitable data or user interface mechanism may be employed. For example, the user interface may be implemented as a virtual keyboard or data entry system as part of a touch-sensitive display.

The apparatus may comprise a microphone 36 or any suitable audio input which may be a digital or analogue signal input. The apparatus 50 may further comprise an audio output device which in embodiments of the examples described herein may be any one of: an earpiece 38, speaker, or an analogue audio or digital audio output connection. The apparatus 50 may also comprise a battery (or in other embodiments of the examples described herein the device may be powered by any suitable mobile energy device such as solar cell, fuel cell or clockwork generator). The apparatus may further comprise a camera 42 capable of recording or capturing images and/or video. The apparatus 50 may further comprise an infrared port for short range line of sight communication to other devices. In other embodiments the apparatus 50 may further comprise any suitable short range communication solution such as, for example, a Bluetooth® wireless connection or a USB/firewire wired connection.

The apparatus 50 may comprise a controller 56, a processor or a processor circuitry for controlling the apparatus 50. The controller 56 may be connected to a memory 58 which in embodiments of the examples described herein may store both data in the form of an image, video data, audio data and/or may also store instructions for implementation on the controller 56. The controller 56 may further be connected to codec circuitry 54 suitable for carrying out coding and/or decoding of audio, image and/or video data or assisting in coding and/or decoding carried out by the controller.

The apparatus 50 may further comprise a card reader 48 and a smart card 46, for example, a UICC and UICC reader for providing user information and being suitable for providing authentication information for authentication and authorization of the user at a network.

The apparatus 50 may comprise radio interface circuitry 52 connected to the controller and suitable for generating wireless communication signals, for example, for communication with a cellular communications network, a wireless communications system or a wireless local area network. The apparatus 50 may further comprise an antenna 44 connected to the radio interface circuitry 52 for transmitting radio frequency signals generated at the radio interface circuitry 52 to other apparatus(es) and/or for receiving radio frequency signals from other apparatus(es).

The apparatus 50 may comprise a camera 42 capable of recording or detecting individual frames which are then passed to the codec 54 or the controller for processing. The apparatus may receive the video image data for processing from another device prior to transmission and/or storage. The apparatus 50 may also receive either wirelessly or by a wired connection the image for coding/decoding. The structural elements of apparatus 50 described above represent examples of means for performing a corresponding function.

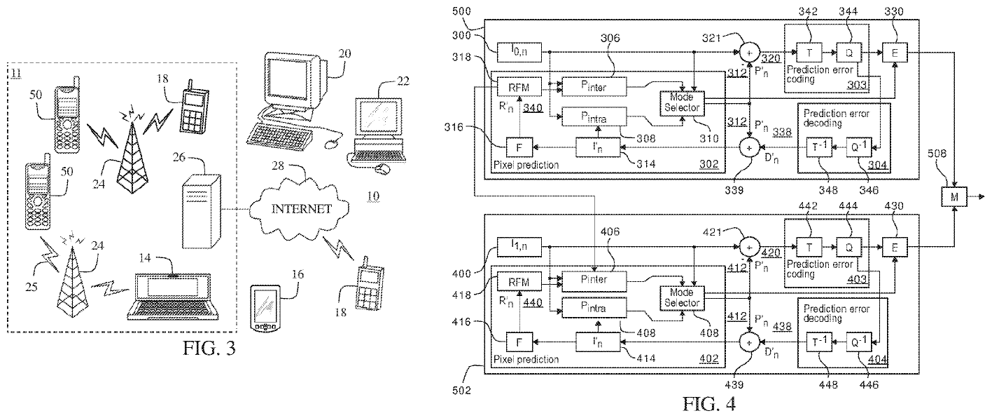

With respect to FIG. 3, an example of a system within which embodiments of the examples described herein can be utilized is shown. The system 10 comprises multiple communication devices which can communicate through one or more networks. The system 10 may comprise any combination of wired or wireless networks including, but not limited, to a wireless cellular telephone network (such as a GSM, UMTS, CDMA, LTE, 4G, 5G network, and the like), a wireless local area network (WLAN) such as defined by any of the IEEE 802.x standards, a Bluetooth® personal area network, an Ethernet local area network, a token ring local area network, a wide area network, and the Internet.

The system 10 may include both wired and wireless communication devices and/or apparatus 50 suitable for implementing embodiments of the examples described herein.

For example, the system shown in FIG. 3 shows a mobile telephone network 11 and a representation of the Internet 28. Connectivity to the Internet 28 may include, but is not limited to, long range wireless connections, short range wireless connections, and various wired connections including, but not limited to, telephone lines, cable lines, power lines, and similar communication pathways.

The example communication devices shown in the system 10 may include, but are not limited to, an electronic device or apparatus 50, a combination of a personal digital assistant (PDA) and a mobile telephone 14, a PDA 16, an integrated messaging device (IMD) 18, a desktop computer 20, a notebook computer 22. The apparatus 50 may be stationary or mobile when carried by an individual who is moving. The apparatus 50 may also be located in a mode of transport including, but not limited to, a car, a truck, a taxi, a bus, a train, a boat, an airplane, a bicycle, a motorcycle or any similar suitable mode of transport.

The embodiments may also be implemented in a set-top box; for example, a digital TV receiver, which may/may not have a display or wireless capabilities, in tablets or (laptop) personal computers (PC), which have hardware and/or software to process neural network data, in various operating systems, and in chipsets, processors, DSPs and/or embedded systems offering hardware/software based coding.

Some or further apparatus may send and receive calls and messages and communicate with service providers through a wireless connection 25 to a base station 24. The base station 24 may be connected to a network server 26 that allows communication between the mobile telephone network 11 and the internet 28. The system may include additional communication devices and communication devices of various types.

The communication devices may communicate using various transmission technologies including, but not limited to, code division multiple access (CDMA), global systems for mobile communications (GSM), universal mobile telecommunications system (UMTS), time divisional multiple access (TDMA), frequency division multiple access (FDMA), transmission control protocol-internet protocol (TCP-IP), short messaging service (SMS), multimedia messaging service (MMS), email, instant messaging service (IMS), Bluetooth®, IEEE 802.11, 3GPP Narrowband IoT and any similar wireless communication technology. A communications device involved in implementing various embodiments of the examples described herein may communicate using various media including, but not limited to, radio, infrared, laser, cable connections, and any suitable connection.

In telecommunications and data networks, a channel may refer either to a physical channel or to a logical channel. A physical channel may refer to a physical transmission medium such as a wire, whereas a logical channel may refer to a logical connection over a multiplexed medium, capable of conveying several logical channels. A channel may be used for conveying an information signal, for example, a bitstream, from one or several senders (or transmitters) to one or several receivers.

The embodiments may also be implemented in internet of things (IoT) devices. The IoT may be defined, for example, as an interconnection of uniquely identifiable embedded computing devices within the existing Internet infrastructure. The convergence of various technologies has and may enable many fields of embedded systems, such as wireless sensor networks, control systems, home/building automation, and the like, to be included the IoT. In order to utilize the Internet, IoT devices are provided with an IP address as a unique identifier. IoT devices may be provided with a radio transmitter, such as WLAN or Bluetooth® transmitter or a RFID tag. Alternatively, IoT devices may have access to an IP-based network via a wired network, such as an Ethernet-based network or a power-line connection (PLC).

An MPEG-2 transport stream (TS), specified in ISO/IEC 13818-1 or equivalently in ITU-T Recommendation H.222.0, is a format for carrying audio, video, and other media as well as program metadata or other metadata, in a multiplexed stream. A packet identifier (PID) is used to identify an elementary stream (a.k.a. packetized elementary stream) within the TS. Hence, a logical channel within an MPEG-2 TS may be considered to correspond to a specific PID value.

Available media file format standards include ISO base media file format (ISO/IEC 14496-12, which may be abbreviated ISOBMFF) and file format for NAL unit structured video (ISO/IEC 14496-15), which derives from the ISOBMFF.

Video codec consists of an encoder that transforms the input video into a compressed representation suited for storage/transmission and a decoder that can decompress the compressed video representation back into a viewable form, or into a form that is suitable as an input to one or more algorithms for analysis or processing. A video encoder and/or a video decoder may also be separate from each other, for example, need not form a codec. Typically, encoder discards some information in the original video sequence in order to represent the video in a more compact form (e.g., at lower bitrate).

Typical hybrid video encoders, for example, many encoder implementations of ITU-T H.263 and H.264, encode the video information in two phases. Firstly pixel values in a certain picture area (or ‘block’) are predicted, for example, by motion compensation means (finding and indicating an area in one of the previously coded video frames that corresponds closely to the block being coded) or by spatial means (using the pixel values around the block to be coded in a specified manner). Secondly the prediction error, for example, the difference between the predicted block of pixels and the original block of pixels, is coded. This is typically done by transforming the difference in pixel values using a specified transform (for example, Discrete Cosine Transform (DCT) or a variant of it), quantizing the coefficients and entropy coding the quantized coefficients. By varying the fidelity of the quantization process, encoder can control the balance between the accuracy of the pixel representation (picture quality) and size of the resulting coded video representation (file size or transmission bitrate).

In temporal prediction, the sources of prediction are previously decoded pictures (a.k.a. reference pictures). In intra block copy (IBC; a.k.a. intra-block-copy prediction and current picture referencing), prediction is applied similarly to temporal prediction, but the reference picture is the current picture and only previously decoded samples can be referred in the prediction process. Inter-layer or inter-view prediction may be applied similarly to temporal prediction, but the reference picture is a decoded picture from another scalable layer or from another view, respectively. In some cases, inter prediction may refer to temporal prediction only, while in other cases inter prediction may refer collectively to temporal prediction and any of intra block copy, inter-layer prediction, and inter-view prediction provided that they are performed with the same or similar process than temporal prediction. Inter prediction or temporal prediction may sometimes be referred to as motion compensation or motion-compensated prediction.

Inter prediction, which may also be referred to as temporal prediction, motion compensation, or motion-compensated prediction, reduces temporal redundancy. In inter prediction the sources of prediction are previously decoded pictures. Intra prediction utilizes the fact that adjacent pixels within the same picture are likely to be correlated. Intra prediction can be performed in spatial or transform domain, for example, either sample values or transform coefficients can be predicted. Intra prediction is typically exploited in intra-coding, where no inter prediction is applied.

One outcome of the coding procedure is a set of coding parameters, such as motion vectors and quantized transform coefficients. Many parameters can be entropy-coded more efficiently when they are predicted first from spatially or temporally neighboring parameters. For example, a motion vector may be predicted from spatially adjacent motion vectors and only the difference relative to the motion vector predictor may be coded. Prediction of coding parameters and intra prediction may be collectively referred to as in-picture prediction.

FIG. 4 shows a block diagram of a general structure of a video encoder. FIG. 4 presents an encoder for two layers, but it would be appreciated that presented encoder could be similarly extended to encode more than two layers. FIG. 4 illustrates a video encoder comprising a first encoder section 500 for a base layer and a second encoder section 502 for an enhancement layer. Each of the first encoder section 500 and the second encoder section 502 may comprise similar elements for encoding incoming pictures. The encoder sections 500, 502 may comprise a pixel predictor 302, 402, prediction error encoder 303, 403 and prediction error decoder 304, 404. FIG. 4 also shows an embodiment of the pixel predictor 302, 402 as comprising an inter-predictor 306, 406, an intra-predictor 308, 408, a mode selector 310, 410, a filter 316, 416, and a reference frame memory 318, 418. The pixel predictor 302 of the first encoder section 500 receives base layer picture(s)/image(s) 300 of a video stream to be encoded at both the inter-predictor 306 (which determines the difference between the image and a motion compensated reference frame) and the intra-predictor 308 (which determines a prediction for an image block based only on the already processed parts of current frame or picture). The output of both the inter-predictor and the intra-predictor are passed to the mode selector 310. The intra-predictor 308 may have more than one intra-prediction modes. Hence, each mode may perform the intra-prediction and provide the predicted signal to the mode selector 310. The mode selector 310 also receives a copy of the base layer image(s) 300. Correspondingly, the pixel predictor 402 of the second encoder section 502 receives enhancement layer picture(s)/images(s) 400 of a video stream to be encoded at both the inter-predictor 406 (which determines the difference between the image and a motion compensated reference frame) and the intra-predictor 408 (which determines a prediction for an image block based only on the already processed parts of current frame or picture). The output of both the inter-predictor and the intra-predictor are passed to the mode selector 410. The intra-predictor 408 may have more than one intra-prediction modes. Hence, each mode may perform the intra-prediction and provide the predicted signal to the mode selector 410. The mode selector 410 also receives a copy of the enhancement layer pictures 400.

Depending on which encoding mode is selected to encode the current block, the output of the inter-predictor 306, 406 or the output of one of the optional intra-predictor modes or the output of a surface encoder within the mode selector is passed to the output of the mode selector 310, 410. The output of the mode selector is passed to a first summing device 321, 421. The first summing device may subtract the output of the pixel predictor 302, 402 from the base layer image(s) 300/enhancement layer image(s) 400 to produce a first prediction error signal 320, 420 which is input to the prediction error encoder 303, 403.

The pixel predictor 302, 402 further receives from a preliminary reconstructor 339, 439 the combination of the prediction representation of the image block 312, 412 and the output 338, 438 of the prediction error decoder 304, 404. The preliminary reconstructed image 314, 414 may be passed to the intra-predictor 308, 408 and to the filter 316, 416. The filter 316, 416 receiving the preliminary representation may filter the preliminary representation and output a final reconstructed image 340, 440 which may be saved in the reference frame memory 318, 418. The reference frame memory 318 may be connected to the inter-predictor 306 to be used as the reference image against which a future base layer image 300 is compared in inter-prediction operations. Subject to the base layer being selected and indicated to be source for inter-layer sample prediction and/or inter-layer motion information prediction of the enhancement layer according to some embodiments, the reference frame memory 318 may also be connected to the inter-predictor 406 to be used as the reference image against which a future enhancement layer image(s) 400 is compared in inter-prediction operations. Moreover, the reference frame memory 418 may be connected to the inter-predictor 406 to be used as the reference image against which the future enhancement layer image(s) 400 is compared in inter-prediction operations.

Filtering parameters from the filter 316 of the first encoder section 500 may be provided to the second encoder section 502 subject to the base layer being selected and indicated to be source for predicting the filtering parameters of the enhancement layer according to some embodiments.

The prediction error encoder 303, 403 comprises a transform unit 342, 442 and a quantizer 344, 444. The transform unit 342, 442 transforms the first prediction error signal 320, 420 to a transform domain. The transform is, for example, the DCT transform. The quantizer 344, 444 quantizes the transform domain signal, for example, the DCT coefficients, to form quantized coefficients.

The prediction error decoder 304, 404 receives the output from the prediction error encoder 303, 403 and performs the opposite processes of the prediction error encoder 303, 403 to produce a decoded prediction error signal 338, 438 which, when combined with the prediction representation of the image block 312, 412 at the second summing device 339, 439, produces the preliminary reconstructed image 314, 414. The prediction error decoder may be considered to comprise a dequantizer 346, 446, which dequantizes the quantized coefficient values, for example, DCT coefficients, to reconstruct the transform signal and an inverse transformation unit 348, 448, which performs the inverse transformation to the reconstructed transform signal wherein the output of the inverse transformation unit 348, 448 contains reconstructed block(s). The prediction error decoder may also comprise a block filter which may filter the reconstructed block(s) according to further decoded information and filter parameters.

The entropy encoder 330, 430 receives the output of the prediction error encoder 303, 403 and may perform a suitable entropy encoding/variable length encoding on the signal to provide a compressed signal. The outputs of the entropy encoders 330, 430 may be inserted into a bitstream, for example, by a multiplexer 508.

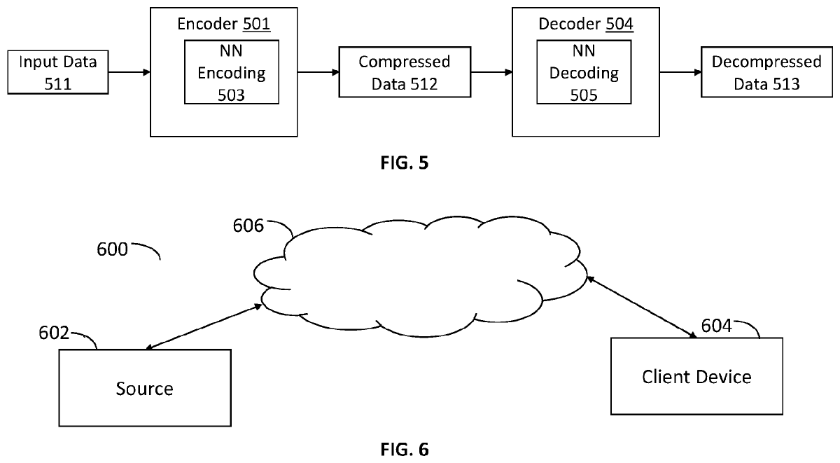

FIG. 5 is a block diagram showing the interface between an encoder 501 implementing neural network encoding 503, and a decoder 504 implementing neural network decoding 505 in accordance with the examples described herein. The encoder 501 may embody a device, a software method or a hardware circuit. The encoder 501 has the goal of compressing an input data 511 (for example, an input video) to a compressed data 512 (for example, a bitstream) such that the bitrate is minimized, and the accuracy of an analysis or processing algorithm is maximized. To this end, the encoder 501 uses an encoder or compression algorithm, for example, to perform neural network encoding 503, e.g., encoding the input data by using one or more neural networks.

The general analysis or processing algorithm may be part of the decoder 504. The decoder 504 uses a decoder or decompression algorithm, for example, to perform the neural network decoding 505 (e.g., decoding by using one or more neural networks) to decode the compressed data 512 (for example, compressed video) which was encoded by the encoder 501. The decoder 504 produces decompressed data 513 (for example, reconstructed data).

The encoder 501 and decoder 504 may be entities implementing an abstraction, may be separate entities or the same entities, or may be part of the same physical device.

An out-of-band transmission, signaling, or storage may refer to the capability of transmitting, signaling, or storing information in a manner that associates the information with a video bitstream. The out-of-band transmission may use a more reliable transmission mechanism compared to the protocols used for carrying coded video data, such as slices. The out-of-band transmission, signaling or storage may additionally or alternatively be used, e.g., for ease of access or session negotiation. For example, a sample entry of a track in a file conforming to the ISO Base Media File Format may comprise parameter sets, while the coded data in the bitstream is stored elsewhere in the file or in another file. Another example of out-of-band transmission, signaling, or storage comprises including information, such as NN and/or NN updates in a file format track that is separate from track(s) including coded video data.

The phrase along the bitstream (e.g., indicating along the bitstream) or along a coded unit of a bitstream (e.g., indicating along a coded tile) may be used in claims and described embodiments to refer to transmission, signaling, or storage in a manner that the ‘out-of-band’ data is associated with, but not included within, the bitstream or the coded unit, respectively. The phrase decoding along the bitstream or along a coded unit of a bitstream or alike may refer to decoding the referred out-of-band data (which may be obtained from out-of-band transmission, signaling, or storage) that is associated with the bitstream or the coded unit, respectively. For example, the phrase along the bitstream may be used when the bitstream is included in a container file, such as a file conforming to the ISO Base Media File Format, and certain file metadata is stored in the file in a manner that associates the metadata to the bitstream, such the sample entry for a track including the bitstream, a sample group for the track including the bitstream, or a timed metadata track associated with the track including the bitstream. In another example, the phrase along the bitstream may be used when the bitstream is made available as a stream over a communication protocol and a media description, such as a streaming manifest, is provided to describe the stream.

An elementary unit for the output of a video encoder and the input of a video decoder, respectively, may be a network abstraction layer (NAL) unit. For transport over packet-oriented networks or storage into structured files, NAL units may be encapsulated into packets or similar structures. A bytestream format encapsulating NAL units may be used for transmission or storage environments that do not provide framing structures. The bytestream format may separate NAL units from each other by attaching a start code in front of each NAL unit. To avoid false detection of NAL unit boundaries, encoders may run a byte-oriented start code emulation prevention algorithm, which may add an emulation prevention byte to the NAL unit payload when a start code would have occurred otherwise. In order to enable straightforward gateway operation between packet and stream-oriented systems, start code emulation prevention may be performed regardless of whether the bytestream format is in use or not. A NAL unit may be defined as a syntax structure including an indication of the type of data to follow and bytes including that data in the form of a raw byte sequence payload interspersed as necessary with emulation prevention bytes. A raw byte sequence payload (RBSP) may be defined as a syntax structure including an integer number of bytes that is encapsulated in a NAL unit. An RBSP is either empty or has the form of a string of data bits including syntax elements followed by an RBSP stop bit and followed by zero or more subsequent bits equal to 0.

In some coding standards, NAL units consist of a header and payload. The NAL unit header indicates the type of the NAL unit. In some coding standards, the NAL unit header indicates a scalability layer identifier (e.g., called nuh_layer_id in H.265/HEVC and H.266/VVC), which could be used e.g., for indicating spatial or quality layers, views of a multiview video, or auxiliary layers (such as depth maps or alpha planes). In some coding standards, the NAL unit header includes a temporal sublayer identifier, which may be used for indicating temporal subsets of the bitstream, such as a 30-frames-per-second subset of a 60-frames-per-second bitstream.

NAL units may be categorized into Video Coding Layer (VCL) NAL units and non-VCL NAL units. VCL NAL units are typically coded slice NAL units.

A non-VCL NAL unit may be, for example, one of the following types: a video parameter set (VPS), a sequence parameter set (SPS), a picture parameter set (PPS), an adaptation parameter set (APS), a supplemental enhancement information (SEI) NAL unit, an access unit delimiter, an end of sequence NAL unit, an end of bitstream NAL unit, or a filler data NAL unit. Parameter sets may be needed for the reconstruction of decoded pictures, whereas many of the other non-VCL NAL units are not necessary for the reconstruction of decoded sample values.

Some coding formats specify parameter sets that may carry parameter values needed for the decoding or reconstruction of decoded pictures. A parameter may be defined as a syntax element of a parameter set. A parameter set may be defined as a syntax structure that contains parameters and that can be referred to from or activated by another syntax structure, for example, using an identifier.

Some types of parameter sets are briefly described in the following, but it needs to be understood, that other types of parameter sets may exist and that embodiments may be applied, but are not limited to, the described types of parameter sets.

Parameters that remain unchanged through a coded video sequence may be included in a sequence parameter set. Alternatively, the SPS may be limited to apply to a layer that references the SPS, e.g., the SPS may remain valid for a coded layer video sequence. In addition to the parameters that may be needed by the decoding process, the sequence parameter set may optionally include video usability information (VUI), which includes parameters that may be important for buffering, picture output timing, rendering, and resource reservation.

A picture parameter set contains such parameters that are likely to be unchanged in several coded pictures. A picture parameter set may include parameters that can be referred to by the VCL NAL units of one or more coded pictures.

A video parameter set (VPS) may be defined as a syntax structure including syntax elements that apply to zero or more entire coded video sequences and may include parameters applying to multiple layers. The VPS may provide information about the dependency relationships of the layers in a bitstream, as well as many other information that are applicable to all slices across all layers in the entire coded video sequence.

A video parameter set RBSP may include parameters that can be referred to by one or more sequence parameter set RBSPs.

The relationship and hierarchy between the VPS, the SPS, and the PPS may be described as follows. A VPS resides one level above an SPS in the parameter set hierarchy and in the context of scalability. The VPS may include parameters that are common for all slices across all layers in the entire coded video sequence. The SPS includes the parameters that are common for all slices in a particular layer in the entire coded video sequence, and may be shared by multiple layers. The PPS includes the parameters that are common for all slices in a particular picture and are likely to be shared by all slices in multiple pictures.

The APS may be specified in some coding formats, such as H.266/VVC. The APS may be applied to one or more image segments, such as slices. In H.266/VVC, the APS may be defined as a syntax structure including syntax elements that apply to zero or more slices as determined by zero or more syntax elements found in slice headers or in a picture header. The APS may comprise a type (aps_params_type in H.266/VVC) and an identifier (aps_adaptation_parameter_set_id in H.266/VVC). The combination of an APS type and an APS identifier may be used to identify a particular APS. H.266/VVC comprises three APS types: an adaptive loop filtering (ALF), a luma mapping with chroma scaling (LMCS), and a scaling list APS types. The ALF APS(s) are referenced from a slice header (thus, the referenced ALF APSs can change slice by slice), and the LMCS and scaling list APS(s) are referenced from a picture header (thus, the referenced LMCS and scaling list APSs can change picture by picture). In H.266/VVC, the APS RBSP has the following syntax:

| | Descriptor |
|---|---|
| adaptation_parameter_set_rbsp( ) { | |
| aps_params_type | u(3) |
| aps_adaptation_parameter_set_id | u(5) |
| aps_chroma_present_flag | u(1) |
| if( aps_params_type = = ALF_APS ) | |
| alf_data( ) | |
| else if( aps_params_type = = LMCS_APS ) | |
| lmcs_data( ) | |
| else if( aps_params_type = = SCALING_APS ) | |
| scaling_list_data( ) | |
| aps_extension_flag | u(1) |
| if( aps_extension_flag ) | |
| while( more_rbsp_data( ) ) | |
| aps_extension_data_flag | u(1) |
| rbsp_trailing_bits( ) | |
| } | |

Video coding specifications may enable the use of supplemental enhancement information (SEI) messages or alike. Some video coding specifications include SEI NAL units, and some video coding specifications include both prefix SEI NAL units and suffix SEI NAL units. A prefix SEI NAL unit can start a picture unit or alike; and a suffix SEI NAL unit can end a picture unit or alike. Hereafter, an SEI NAL unit may equivalently refer to a prefix SEI NAL unit or a suffix SEI NAL unit. An SEI NAL unit includes one or more SEI messages, which are not required for the decoding of output pictures but may assist in related processes, such as picture output timing, post-processing of decoded pictures, rendering, error detection, error concealment, and resource reservation.

Several SEI messages are specified in H.264/AVC, H.265/HEVC, H.266/VVC, and H.274/VSEI standards, and the user data SEI messages enable organizations and companies to specify SEI messages for specific use. The standards may include the syntax and semantics for the specified SEI messages but a process for handling the messages in the recipient might not be defined. Consequently, encoders may be required to follow the standard specifying a SEI message when they create SEI message(s), and decoders might not be required to process SEI messages for output order conformance. One of the reasons to include the syntax and semantics of SEI messages in standards is to allow different system specifications to interpret the supplemental information identically and hence interoperate. It is intended that system specifications can require the use of particular SEI messages both in the encoding end and in the decoding end, and additionally the process for handling particular SEI messages in the recipient can be specified.

The method and apparatus of an example embodiment may be utilized in a wide variety of systems, including systems that rely upon the compression and decompression of media data and possibly also the associated metadata. In one embodiment, however, the method and apparatus are configured to compress the media data and associated metadata streamed from a source via a content delivery network to a client device, at which point the compressed media data and associated metadata is decompressed or otherwise processed. In this regard, FIG. 6 depicts an example of such a system 600 that includes a source 602 of media data and associated metadata. The source may be, in one embodiment, a server. However, the source may be embodied in other manners when so desired. The source is configured to stream the media data and associated metadata to a client device 604. The client device may be embodied by a media player, a multimedia system, a video system, a smart phone, a mobile telephone or other user equipment, a personal computer, a tablet computer or any other computing device configured to receive and decompress the media data and process associated metadata. In the illustrated embodiment, media data and metadata are streamed via a network 606, such as any of a wide variety of types of wireless networks and/or wireline networks. The client device is configured to receive structured information including media, metadata and any other relevant representation of information including the media and the metadata and to decompress the media data and process the associated metadata (e.g., for proper playback timing of decompressed media data).

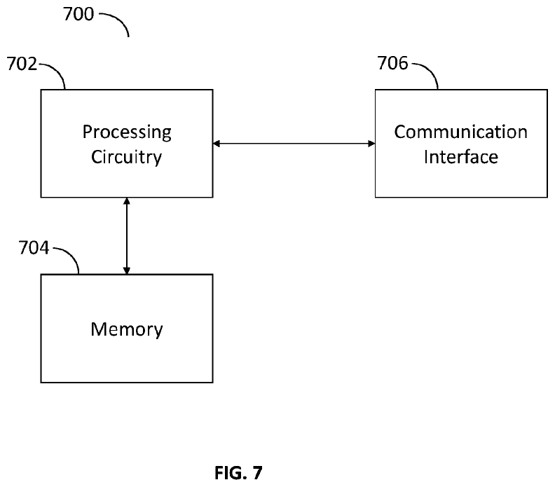

An apparatus 700 is provided in accordance with an example embodiment as shown in FIG. 7. In one embodiment, the apparatus of FIG. 7 may be embodied by the source 602, such as a file writer which, in turn, may be embodied by a server, that is configured to stream a compressed representation of the media data and associated metadata. In an alternative embodiment, the apparatus may be embodied by the client device 604, such as a file reader which may be embodied, for example, by any of the various computing devices described above. In either of these embodiments and as shown in FIG. 7, the apparatus of an example embodiment includes, is associated with or is in communication with a processing circuitry 702, one or more memory devices 704, a communication interface 706, and optionally a user interface.

The processing circuitry 702 may be in communication with the memory device 704 via a bus for passing information among components of the apparatus 700. The memory device may be non-transitory and may include, for example, one or more volatile and/or non-volatile memories. In other words, for example, the memory device may be an electronic storage device (e.g., a computer readable storage medium) comprising gates configured to store data (e.g., bits) that may be retrievable by a machine (e.g., a computing device like the processing circuitry). The memory device may be configured to store information, data, content, applications, instructions, or the like for enabling the apparatus to carry out various functions in accordance with an example embodiment of the present disclosure. For example, the memory device could be configured to buffer input data for processing by the processing circuitry. Additionally or alternatively, the memory device could be configured to store instructions for execution by the processing circuitry.

The apparatus 700 may, in some embodiments, be embodied in various computing devices as described above. However, in some embodiments, the apparatus may be embodied as a chip or chip set. In other words, the apparatus may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present disclosure on a single chip or as a single ‘system on a chip.’ As such, in some cases, a chip or chipset may constitute means for performing one or more operations for providing the functionalities described herein.

The processing circuitry 702 may be embodied in a number of different ways. For example, the processing circuitry may be embodied as one or more of various hardware processing means such as a coprocessor, a microprocessor, a controller, a digital signal processor (DSP), a processing element with or without an accompanying DSP, or various other circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processing circuitry may include one or more processing cores configured to perform independently. A multi-core processing circuitry may enable multiprocessing within a single physical package. Additionally or alternatively, the processing circuitry may include one or more processors configured in tandem via the bus to enable independent execution of instructions, pipelining and/or multithreading.

In an example embodiment, the processing circuitry 702 may be configured to execute instructions stored in the memory device 704 or otherwise accessible to the processing circuitry. Alternatively or additionally, the processing circuitry may be configured to execute hard coded functionality. As such, whether configured by hardware or software methods, or by a combination thereof, the processing circuitry may represent an entity (e.g., physically embodied in circuitry) capable of performing operations according to an embodiment of the present disclosure while configured accordingly. Thus, for example, when the processing circuitry is embodied as an ASIC, FPGA or the like, the processing circuitry may be specifically configured hardware for conducting the operations described herein. Alternatively, as another example, when the processing circuitry is embodied as an executor of instructions, the instructions may specifically configure the processing circuitry to perform the algorithms and/or operations described herein when the instructions are executed. However, in some cases, the processing circuitry may be a processor of a specific device (e.g., an image or video processing system) configured to employ an embodiment of the present invention by further configuration of the processing circuitry by instructions for performing the algorithms and/or operations described herein. The processing circuitry may include, among other things, a clock, an arithmetic logic unit (ALU) and logic gates configured to support operation of the processing circuitry.

The communication interface 706 may be any means such as a device or circuitry embodied in either hardware or a combination of hardware and software that is configured to receive and/or transmit data, including video bitstreams. In this regard, the communication interface may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may alternatively or also support wired communication. As such, for example, the communication interface may include a communication modem and/or other hardware/software for supporting communication via cable, digital subscriber line (DSL), universal serial bus (USB) or other mechanisms.

In some embodiments, the apparatus 700 may optionally include a user interface that may, in turn, be in communication with the processing circuitry 702 to provide output to a user, such as by outputting an encoded video bitstream and, in some embodiments, to receive an indication of a user input. As such, the user interface may include a display and, in some embodiments, may also include a keyboard, a mouse, a joystick, a touch screen, touch areas, soft keys, a microphone, a speaker, or other input/output mechanisms. Alternatively or additionally, the processing circuitry may comprise user interface circuitry configured to control at least some functions of one or more user interface elements such as a display and, in some embodiments, a speaker, ringer, microphone and/or the like. The processing circuitry and/or user interface circuitry comprising the processing circuitry may be configured to control one or more functions of one or more user interface elements through computer program instructions (e.g., software and/or firmware) stored on a memory accessible to the processing circuitry (e.g., memory device, and/or the like).

### Fundamentals of Neural Networks

A neural network (NN) is a computation graph consisting of several layers of computation. Each layer consists of one or more units, where each unit performs a computation. A unit is connected to one or more other units, and a connection may be associated with a weight. The weight may be used for scaling the signal passing through an associated connection. Weights are learnable parameters, for example, values which can be learned from training data. There may be other learnable parameters, such as those of batch-normalization layers.

Couple of examples of architectures for neural networks are feed-forward and recurrent architectures. Feed-forward neural networks are such that there is no feedback loop, each layer takes input from one or more of the previous layers, and provides its output as the input for one or more of the subsequent layers. Also, units inside a certain layer take input from units in one or more of preceding layers and provide output to one or more of following layers.

Initial layers, those close to the input data, extract semantically low-level features, for example, edges and textures in images, and intermediate and final layers extract more high-level features. After the feature extraction layers there may be one or more layers performing a certain task, for example, classification, semantic segmentation, object detection, denoising, style transfer, super-resolution, and the like. In recurrent neural networks, there is a feedback loop, so that the neural network becomes stateful, for example, it is able to memorize information or a state.

Neural networks are being utilized in an ever-increasing number of applications for many different types of devices, for example, mobile phones, chat bots, IoT devices, smart cars, voice assistants, and the like. Some of these applications include, but are not limited to, image and video analysis and processing, social media data analysis, device usage data analysis, and the like.

One of the properties of neural networks, and other machine learning tools, is that they are able to learn properties from input data, either in a supervised way or in an unsupervised way. Such learning is a result of a training algorithm, or of a meta-level neural network providing the training signal.

In general, the training algorithm consists of changing some properties of the neural network so that its output is as close as possible to a desired output. For example, in the case of classification of objects in images, the output of the neural network can be used to derive a class or category index which indicates the class or category that the object in the input image belongs to. Training usually happens by minimizing or decreasing the output error, also referred to as the loss. Examples of losses are mean squared error, cross-entropy, and the like. In recent deep learning techniques, training is an iterative process, where at each iteration the algorithm modifies the weights of the neural network to make a gradual improvement in the network's output, for example, gradually decrease the loss.

Training a neural network is an optimization process, but the final goal is different from the typical goal of optimization. In optimization, the only goal is to minimize a function. In machine learning, the goal of the optimization or training process is to make the model learn the properties of the data distribution from a limited training dataset. In other words, the goal is to learn to use a limited training dataset in order to learn to generalize to previously unseen data, for example, data which was not used for training the model. This is usually referred to as generalization. In practice, data is usually split into at least two sets, the training set and the validation set. The training set is used for training the network, for example, to modify its learnable parameters in order to minimize the loss. The validation set is used for checking the performance of the network on data, which was not used to minimize the loss, as an indication of the final performance of the model. In particular, the errors on the training set and on the validation set are monitored during the training process to understand the following:
when the network is learning—in this case, the training set error should decrease, otherwise the model is in the regime of underfitting.
when the network is learning to generalize—in this case, also the validation set error needs to decrease and be not too much higher than the training set error. For example, the validation set error should be less than 20% higher than the training set error. When the training set error is low, for example, 10% of its value at the beginning of training, or with respect to a threshold that may have been determined based on an evaluation metric, but the validation set error is much higher than the training set error, or it does not decrease, or it even increases, the model is in the regime of overfitting. This means that the model has just memorized the properties of the training set and performs well only on that set, but performs poorly on a set not used for training or tuning its parameters.

Lately, neural networks have been used for compressing and de-compressing data such as images. The most widely used architecture for such task is the auto-encoder, which is a neural network consisting of two parts: a neural encoder and a neural decoder. In various embodiments, these neural encoder and neural decoder would be referred to as encoder and decoder, even though these refer to algorithms which are learned from data instead of being tuned manually. The encoder takes an image as an input and produces a code, to represent the input image, which requires less bits than the input image. This code may have been obtained by a binarization or quantization process after the encoder. The decoder takes in this code and reconstructs the image which was input to the encoder.

Such encoder and decoder are usually trained to minimize a combination of bitrate and distortion, where the distortion may be based on one or more of the following metrics: mean squared error (MSE), peak signal-to-noise ratio (PSNR), structural similarity index measure (SSIM), or the like. These distortion metrics are meant to be correlated to the human visual perception quality, so that minimizing or maximizing one or more of these distortion metrics results into improving the visual quality of the decoded image as perceived by humans.

In various embodiments, terms ‘model’, ‘neural network’, ‘neural net’ and ‘network’ may be used interchangeably, and also the weights of neural networks may be sometimes referred to as learnable parameters or as parameters.

### Fundamentals of Video/Image Coding

Video codec consists of an encoder that transforms the input video into a compressed representation suited for storage/transmission and a decoder that can decompress the compressed video representation back into a viewable form. Typically, an encoder discards some information in the original video sequence in order to represent the video in a more compact form, for example, at lower bitrate.

Typical hybrid video codecs, for example, ITU-T H.263 and H.264, encode the video information in two phases. Firstly, pixel values in a certain picture area (or ‘block’) are predicted. In an example, the pixel values may be predicted by using motion compensation algorithm. This prediction technique includes finding and indicating an area in one of the previously coded video frames that corresponds closely to the block being coded.

In other example, the pixel values may be predicted by using spatial prediction techniques. This prediction technique uses the pixel values around the block to be coded in a specified manner. Secondly, the prediction error, for example, the difference between the predicted block of pixels and the original block of pixels is coded. This is typically done by transforming the difference in pixel values using a specified transform, for example, discrete cosine transform (DCT) or a variant of it; quantizing the coefficients; and entropy coding the quantized coefficients. By varying the fidelity of the quantization process, encoder can control the balance between the accuracy of the pixel representation, for example, picture quality and size of the resulting coded video representation, for example, file size or transmission bitrate.

Inter prediction, which may also be referred to as temporal prediction, motion compensation, or motion-compensated prediction, exploits temporal redundancy. In inter prediction the sources of prediction are previously decoded pictures.

Intra prediction utilizes the fact that adjacent pixels within the same picture are likely to be correlated. Intra prediction can be performed in spatial or transform domain, for example, either sample values or transform coefficients can be predicted. Intra prediction is typically exploited in intra-coding, where no inter prediction is applied.

One outcome of the coding procedure is a set of coding parameters, such as motion vectors and quantized transform coefficients. Many parameters can be entropy-coded more efficiently when they are predicted first from spatially or temporally neighboring parameters. For example, a motion vector may be predicted from spatially adjacent motion vectors and only the difference relative to the motion vector predictor may be coded. Prediction of coding parameters and intra prediction may be collectively referred to as in-picture prediction.

The decoder reconstructs the output video by applying prediction techniques similar to the encoder to form a predicted representation of the pixel blocks. For example, using the motion or spatial information created by the encoder and stored in the compressed representation and prediction error decoding, which is inverse operation of the prediction error coding recovering the quantized prediction error signal in spatial pixel domain. After applying prediction and prediction error decoding techniques the decoder sums up the prediction and prediction error signals, for example, pixel values to form the output video frame. The decoder and encoder can also apply additional filtering techniques to improve the quality of the output video before passing it for display and/or storing it as prediction reference for the forthcoming frames in the video sequence.

In typical video codecs the motion information is indicated with motion vectors associated with each motion compensated image block. Each of these motion vectors represents the displacement of the image block in the picture to be coded in the encoder side or decoded in the decoder side and the prediction source block in one of the previously coded or decoded pictures.

In order to represent motion vectors efficiently, the motion vectors are typically coded differentially with respect to block specific predicted motion vectors. In typical video codecs, the predicted motion vectors are created in a predefined way, for example, calculating the median of the encoded or decoded motion vectors of the adjacent blocks.

Another way to create motion vector predictions is to generate a list of candidate predictions from adjacent blocks and/or co-located blocks in temporal reference pictures and signaling the chosen candidate as the motion vector predictor. In addition to predicting the motion vector values, the reference index of previously coded/decoded picture can be predicted. The reference index is typically predicted from adjacent blocks and/or or co-located blocks in temporal reference picture.

Moreover, typical high efficiency video codecs employ an additional motion information coding/decoding mechanism, often called merging/merge mode, where all the motion field information, which includes motion vector and corresponding reference picture index for each available reference picture list, is predicted and used without any modification/correction. Similarly, predicting the motion field information is carried out using the motion field information of adjacent blocks and/or co-located blocks in temporal reference pictures and the used motion field information is signaled among a list of motion field candidate list filled with motion field information of available adjacent/co-located blocks.

In typical video codecs, the prediction residual after motion compensation is first transformed with a transform kernel, for example, DCT and then coded. The reason for this is that often there still exists some correlation among the residual and transform can in many cases help reduce this correlation and provide more efficient coding.

Typical video encoders utilize Lagrangian cost functions to find optimal coding modes, for example, the desired macroblock mode and associated motion vectors. This kind of cost function uses a weighting factor λ to tie together the exact or estimated image distortion due to lossy coding methods and the exact or estimated amount of information that is required to represent the pixel values in an image area:

$$C = D + λ R \qquad equation 1$$

In equation 1, C is the Lagrangian cost to be minimized, D is the image distortion, for example, mean squared error with the mode and motion vectors considered, and R is the number of bits needed to represent the required data to reconstruct the image block in the decoder including the amount of data to represent the candidate motion vectors.

Video coding specifications may enable the use of supplemental enhancement information (SEI) messages or alike. Some video coding specifications include SEI NAL units, and some video coding specifications include both prefix SEI NAL units and suffix SEI NAL units, where the former type can start a picture unit or alike and the latter type can end a picture unit or alike. An SEI NAL unit contains one or more SEI messages, which are not required for the decoding of output pictures but may assist in related processes, such as picture output timing, post-processing of decoded pictures, rendering, error detection, error concealment, and resource reservation.

Several SEI messages are specified in H.264/AVC, H.265/HEVC, H.266/VVC, and H.274/VSEI standards, and the user data SEI messages enable organizations and companies to specify SEI messages for their own use. The standards may include the syntax and semantics for the specified SEI messages but a process for handling the messages in the recipient might not be defined. Consequently, encoders may be required to follow the standard specifying a SEI message when they create SEI message(s), and decoders might not be required to process SEI messages for output order conformance. One of the reasons to include the syntax and semantics of SEI messages in standards is to allow different system specifications to interpret the supplemental information identically and hence interoperate. It is intended that system specifications can require the use of particular SEI messages both in the encoding end and in the decoding end, and additionally the process for handling particular SEI messages in the recipient can be specified.

A design principle has been followed for SEI message specifications: the SEI messages are generally not extended in future amendments or versions of the standard.

### Filters in Video Codecs

Conventional image and video codecs use a set of filters to enhance the visual quality of the predicted visual content and can be applied either in-loop or out-of-loop, or both. In the case of in-loop filters, the filter applied on one block in the currently-encoded frame may affect the encoding of another block in the same frame and/or in another frame which is predicted from the current frame. An in-loop filter can affect the bitrate and/or the visual quality. An enhanced block may cause a smaller residual, difference between original block and predicted-and-filtered block, thus using less bits in the bitstream output by the encoder. An out-of-loop filter may be applied on a frame after it has been reconstructed, the filtered visual content may not be a source for prediction, and thus it may only impact the visual quality of the frames that are output by the decoder.

### Information on Neural Network Based Image/Video Coding

Recently, neural networks (NNs) have been used in the context of image and video compression, by following mainly two approaches.

In one approach, NNs are used to replace or are used as an addition to one or more of the components of a traditional codec such as VVC/H.266. Here ‘traditional’ means, those codecs whose components and parameters are typically not learned from data by means of a training process, for example, those codecs whose components are not neural networks. Some examples of uses of neural networks within a traditional codec include but are not limited to:
Additional in-loop filter, for example, by having the NN as an additional in-loop filter with respect to the traditional loop filters;
Single in-loop filter, for example, by having the NN replacing all traditional in-loop filters.
Intra-frame prediction, for example, as an additional intra-frame prediction mode, or; replacing the traditional intra-frame prediction;
Inter-frame prediction, for example, as an additional inter-frame prediction mode, or replacing the traditional inter-frame prediction;
Transform and/or inverse transform, for example, as an additional transform and/or inverse transform, or replacing the traditional transform and/or inverse transform; and
Probability model for the arithmetic codec, for example, as an additional probability model, or replacing the traditional probability model.

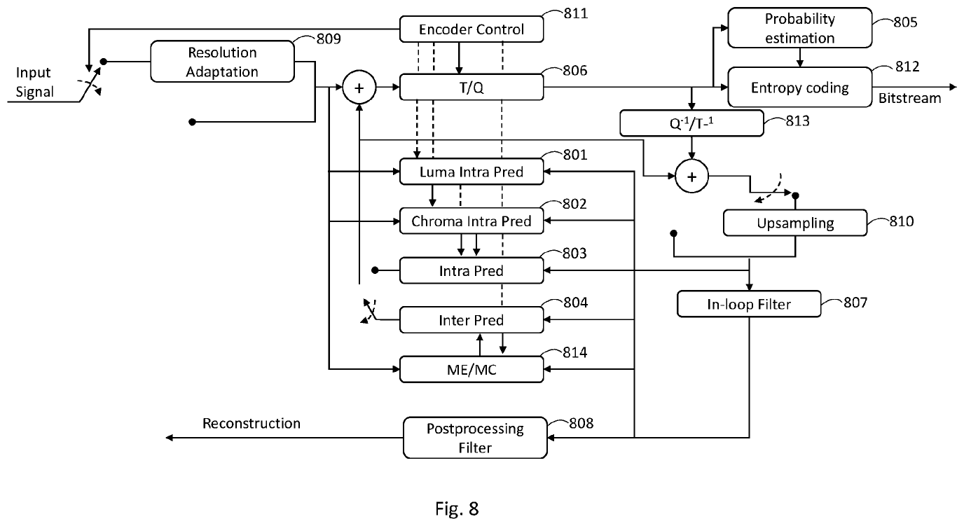

FIG. 8 illustrates examples of functioning of NNs as components of a pipeline of a traditional codec, in accordance with an embodiment. In particular, FIG. 8 illustrates an encoder, which also includes a decoding loop. FIG. 8 is shown to include components described below:
A luma intra pred block or circuit 801. This block or circuit performs intra prediction in the luma domain, for example, by using already reconstructed data from the same frame. The operation of the luma intra pred block or circuit 801 may be performed by a deep neural network such as a convolutional auto-encoder.
A chroma intra pred block or circuit 802. This block or circuit performs intra prediction in the chroma domain, for example, by using already reconstructed data from the same frame.

The chroma intra pred block or circuit 802 may perform cross-component prediction, for example, predicting chroma from luma. The operation of the chroma intra pred block or circuit 802 may be performed by a deep neural network such as a convolutional auto-encoder.
An intra pred block or circuit 803 and an inter-pred block or circuit 804. These blocks or circuit perform intra prediction and inter-prediction, respectively. The intra pred block or circuit 803 and the inter-pred block or circuit 804 may perform the prediction on all components, for example, luma and chroma. The operations of the intra pred block or circuit 803 and the inter-pred block or circuit 804 may be performed by two or more deep neural networks such as convolutional auto-encoders.
A probability estimation block or circuit 805 for entropy coding. This block or circuit performs prediction of probability for the next symbol to encode or decode, which is then provided to the entropy coding module 812, such as the arithmetic coding module, to encode or decode the next symbol. The operation of the probability estimation block or circuit 805 may be performed by a neural network.
A transform and quantization (T/Q) block or circuit 806. These are actually two blocks or circuits. The transform and quantization block or circuit 806 may perform a transform of input data to a different domain, for example, the FFT transform would transform the data to frequency domain. The transform and quantization block or circuit 806 may quantize its input values to a smaller set of possible values. In the decoding loop, there may be inverse quantization block or circuit and inverse transform block or circuit Q⁻¹/T⁻¹ 813. One or both of the transform block or circuit and quantization block or circuit may be replaced by one or two or more neural networks. One or both of the inverse transform block or circuit and inverse quantization block or circuit 813 may be replaced by one or two or more neural networks.
An in-loop filter block or circuit 807. Operations of the in-loop filter block or circuit 807 is performed in the decoding loop, and it performs filtering on the output of the inverse transform block or circuit, or on the reconstructed data, in order to enhance the reconstructed data with respect to one or more predetermined quality metrics. This filter may affect both the quality of the decoded data and the bitrate of the bitstream output by the encoder. The operation of the in-loop filter block or circuit 807 may be performed by a neural network, such as a convolutional auto-encoder. In examples, the operation of the in-loop filter may be performed by multiple steps or filters, where the one or more steps may be performed by neural networks.
A post-processing filter block or circuit 808. The post-processing filter block or circuit 808 may be performed only at decoder side, as it may not affect the encoding process. The post-processing filter block or circuit 808 filters the reconstructed data output by the in-loop filter block or circuit 807, in order to enhance the reconstructed data. The post-processing filter block or circuit 808 may be replaced by a neural network, such as a convolutional auto-encoder.
A resolution adaptation block or circuit 809: this block or circuit may downsample the input video frames, prior to encoding. Then, in the decoding loop, the reconstructed data may be upsampled, by the upsampling block or circuit 810, to the original resolution. The operation of the resolution adaptation block or circuit 809 block or circuit may be performed by a neural network such as a convolutional auto-encoder.
An encoder control block or circuit 811. This block or circuit performs optimization of encoder's parameters, such as what transform to use, what quantization parameters (QP) to use, what intra-prediction mode (out of N intra-prediction modes) to use, and the like. The operation of the encoder control block or circuit 811 may be performed by a neural network, such as a classifier convolutional network, or such as a regression convolutional network.
An ME/MC block or circuit 814 performs motion estimation and/or motion compensation, which are two key operations to be performed when performing inter-frame prediction. ME/MC stands for motion estimation/motion compensation

In another approach, commonly referred to as ‘end-to-end learned compression’, NNs are used as the main components of the image/video codecs. Some examples of the second approach include, but are not limited to following:

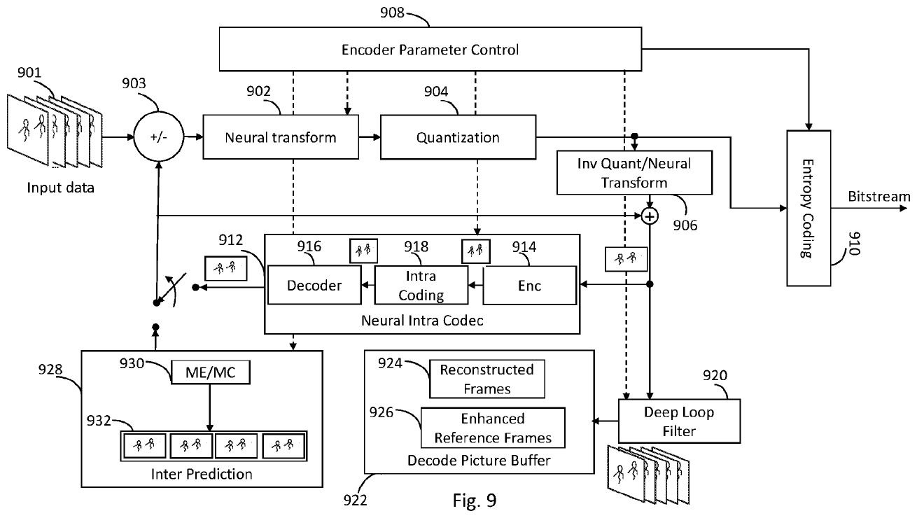

Option 1: re-use the video coding pipeline but replace most or all the components with NNs. Referring to FIG. 9, it illustrates an example of modified video coding pipeline based on neural network, in accordance with an embodiment. An example of neural network may include, but is not limited, a compressed representation of a neural network. FIG. 9 is shown to include following components:
A neural transform block or circuit 902: this block or circuit transforms the output of a summation/subtraction operation 903 to a new representation of that data, which may have lower entropy and thus be more compressible.
A quantization block or circuit 904: this block or circuit quantizes an input data 901 to a smaller set of possible values.
An inverse transform and inverse quantization blocks or circuits 906. These blocks or circuits perform the inverse or approximately inverse operation of the transform and the quantization, respectively.
An encoder parameter control block or circuit 908. This block or circuit may control and optimize some or all the parameters of the encoding process, such as parameters of one or more of the encoding blocks or circuits.
An entropy coding block or circuit 910. This block or circuit may perform lossless coding, for example, based on entropy. One popular entropy coding technique is arithmetic coding.
A neural intra-codec block or circuit 912. This block or circuit may be an image compression and decompression block or circuit, which may be used to encode and decode an intra frame. An encoder 914 may be an encoder block or circuit, such as the neural encoder part of an auto-encoder neural network. A decoder 916 may be a decoder block or circuit, such as the neural decoder part of an auto-encoder neural network. An intra-coding block or circuit 918 may be a block or circuit performing some intermediate steps between encoder and decoder, such as quantization, entropy encoding, entropy decoding, and/or inverse quantization.
A deep loop filter block or circuit 920. This block or circuit performs filtering of reconstructed data, in order to enhance it.
A decode picture buffer block or circuit 922. This block or circuit is a memory buffer, keeping the decoded frame, for example, reconstructed frames 924 and enhanced reference frames 926 to be used for inter prediction.
An inter-prediction block or circuit 928. This block or circuit performs inter-frame prediction, for example, predicts from frames, for example, frames 932, which are temporally nearby. An ME/MC 930 performs motion estimation and/or motion compensation, which are two key operations to be performed when performing inter-frame prediction. ME/MC stands for motion estimation/motion compensation.

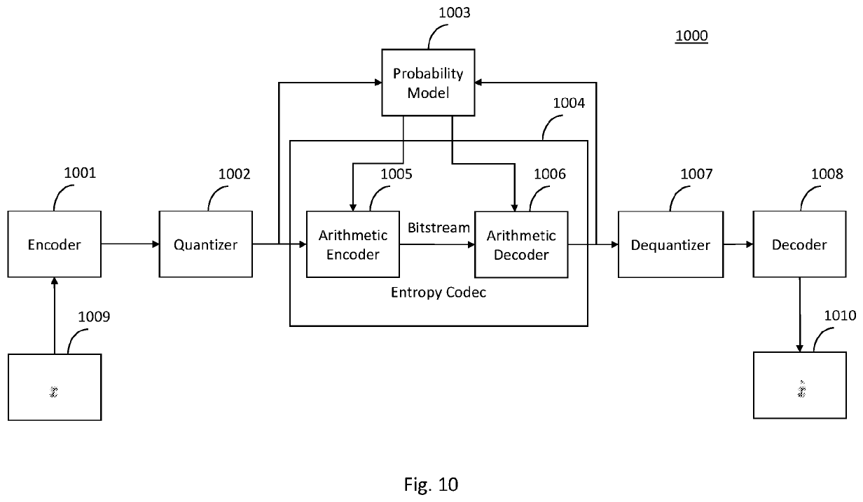

In order to train the neural networks of this system, a training objective function, referred to as ‘training loss’, is typically utilized, which usually comprises one or more terms, or loss terms, or simply losses. Although here the Option 2 and FIG. 10 considered as example for describing the training objective function, a similar training objective function may also be used for training the neural networks for the systems in FIG. 6 and FIG. 7. In one example, the training loss comprises a reconstruction loss term and a rate loss term. The reconstruction loss encourages the system to decode data that is similar to the input data, according to some similarity metric. Following are some examples of reconstruction losses:
a loss derived from mean squared error (MSE);
a loss derived from multi-scale structural similarity (MS-SSIM), such as 1 minus MS-SSIM, or 1−MS-SSIM;
losses derived from the use of a pretrained neural network. For example, error(f1, f2), where f1 and f2 are the features extracted by a pretrained neural network for the input (uncompressed) data and the decoded (reconstructed) data, respectively, and error( ) is an error or distance function, such as L1 norm or L2 norm; and
losses derived from the use of a neural network that is trained simultaneously with the end-to-end learned codec. For example, adversarial loss can be used, which is the loss provided by a discriminator neural network that is trained adversarially with respect to the codec, following the settings proposed in the context of generative adversarial networks (GANs) and their variants.

The rate loss encourages the system to compress the output of the encoding stage, such as the output of the arithmetic encoder. ‘Compressing’ for example, means reducing the number of bits output by the encoding stage.

When an entropy-based lossless encoder is used, such as the arithmetic encoder, the rate loss typically encourages the output of the Encoder NN to have low entropy. The rate loss may be computed on the output of the Encoder NN, or on the output of the quantization operation, or on the output of the probability model. Following are some example of rate losses:
A differentiable estimate of the entropy;
A sparsification loss, for example, a loss that encourages the output of the Encoder NN or the output of the quantization to have many zeros. Examples are L0 norm, L1 norm, L1 norm divided by L2 norm; and
A cross-entropy loss applied to the output of a probability model, where the probability model may be a NN used to estimate the probability of the next symbol to be encoded by the arithmetic encoder.

For training one or more neural networks that are part of a codec, such as one or more neural networks in FIG. 8 and/or FIG. 9, one or more of reconstruction losses may be used, and one or more of rate losses may be used. The loss terms may then be combined, for example, as a weighted sum to obtain the training objective function. Typically, the different loss terms are weighted using different weights, and these weights determine how the final system performs in terms of rate-distortion loss. For example, when more weight is given to one or more of the reconstruction losses with respect to the rate losses, the system may learn to compress less but to reconstruct with higher accuracy as measured by a metric that correlates with the reconstruction losses. These weights are usually considered to be hyper-parameters of the training session and may be set manually by the operator designing the training session, or automatically, for example, by grid search or by using additional neural networks.

For the sake of explanation, video is considered as data type in various embodiments. However, it would be understood that the embodiments are also applicable to other media items, for example, images and audio data.

It is to be understood that even in end-to-end learned approaches, there may be components which are not learned from data, such as an arithmetic codec.

Option 2 is illustrated in FIG. 10, and it consists of a different type of codec architecture. Referring to FIG. 10, it illustrates an example neural network-based end-to-end learned video coding system, in accordance with an example embodiment. As shown FIG. 10, a neural network-based end-to-end learned video coding system 1000 includes an encoder 1001, a quantizer 1002, a probability model 1003, an entropy codec 1004, for example, an arithmetic encoder 1005 and an arithmetic decoder 1006, a dequantizer 1007, and a decoder 1008. The encoder 1001 and the decoder 1008 are typically two neural networks, or comprise neural network components. The probability model 1003 may also comprise mainly neural network components. The quantizer 1002, the dequantizer 1007, and the entropy codec 1004 are typically not based on neural network components, but they may also potentially comprise neural network components. In some embodiments, the encoder, quantizer, probability model, entropy codec, arithmetic encoder, arithmetic decoder, dequantizer, and decoder, may also be referred to as an encoder component, quantizer component, probability model component, entropy codec component, arithmetic encoder component, arithmetic decoder component, dequantizer component, and decoder component respectively.

On the encoding side, the encoder 1001 takes a video/image as an input 1009 and converts the video/image in original signal space into a latent representation that may comprise a more compressible representation of the input. The latent representation may be normally a 3-dimensional tensor for image compression, where 2 dimensions represent spatial information and the third dimension contains information at that specific location.

Consider an example, in which the input data is an image, when the input image is a 128×128×3 RGB image (with horizontal size of 128 pixels, vertical size of 128 pixels, and 3 channels for the Red, Green, Blue color components), and when the encoder downsamples the input tensor by 2 and expands the channel dimension to 32 channels, then the latent representation is a tensor of dimensions (or ‘shape’) 64×64×32 (e.g, with horizontal size of 64 elements, vertical size of 64 elements, and 32 channels). Please note that the order of the different dimensions may differ depending on the convention which is used. In some embodiments, for the input image, the channel dimension may be the first dimension, so for the above example, the shape of the input tensor may be represented as 3×128×128, instead of 128×128×3.

In the case of an input video (instead of just an input image), another dimension in the input tensor may be used to represent temporal information.

The quantizer 1002 quantizes the latent representation into discrete values given a predefined set of quantization levels. The probability model 1003 and the arithmetic encoder 1005 work together to perform lossless compression for the quantized latent representation and generate bitstreams to be sent to the decoder side. Given a symbol to be encoded to the bitstream, the probability model 1003 estimates the probability distribution of all possible values for that symbol based on a context that is constructed from available information at the current encoding/decoding state, such as the data that has already encoded/decoded. The arithmetic encoder 1005 encodes the input symbols to bitstream using the estimated probability distributions.

On the decoding side, opposite operations are performed. The arithmetic decoder 1006 and the probability model 1003 first decode symbols from the bitstream to recover the quantized latent representation. Then, the dequantizer 1007 reconstructs the latent representation in continuous values and pass it to the decoder 1008 to recover the input video/image. The recovered input video/image is provided as an output 1010. Note that the probability model 1003, in this system 1000, is shared between the arithmetic encoder 1005 and the arithmetic decoder 1006. In practice, this means that a copy of the probability model 1003 is used at the arithmetic encoder 1005 side, and another exact copy is used at the arithmetic decoder 1006 side.

In this system 1000, the encoder 1001, the probability model 1003, and the decoder 1008 are normally based on deep neural networks. The system 1000 is trained in an end-to-end manner by minimizing the following rate-distortion loss function, which may be referred to simply as training loss, or loss:

$$L = D + λ R \qquad equation 2$$

In equation 2, D is the distortion loss term, R is the rate loss term, and 2 is the weight that controls the balance between the two losses.

The distortion loss term may be referred to also as reconstruction loss. It encourages the system to decode data that is similar to the input data, according to some similarity metric. Following are some examples of reconstruction losses:
a loss derived from mean squared error (MSE);
a loss derived from multi-scale structural similarity (MS-SSIM), such as 1 minus MS-SSIM, or 1−MS-SSIM;
losses derived from the use of a pretrained neural network. For example, error(f1, f2), where f1 and f2 are the features extracted by a pretrained neural network for the input (uncompressed) data and the decoded (reconstructed) data, respectively, and error( ) is an error or distance function, such as L1 norm or L2 norm; and
losses derived from the use of a neural network that is trained simultaneously with the end-to-end learned codec. For example, adversarial loss can be used, which is the loss provided by a discriminator neural network that is trained adversarially with respect to the codec, following the settings proposed in the context of generative adversarial networks (GANs) and their variants.

Multiple distortion losses may be used and integrated into D.

Minimizing the rate loss encourages the system to compress the quantized latent representation so that the quantized latent representation can be represented by a smaller number of bits. The rate loss may be computed on the output of the encoder NN, or on the output of the quantization operation, or on the output of the probability model. In one example embodiment, the rate loss may comprise multiple rate losses. Some example of rate losses are the following:
a differentiable estimate of the entropy of the quantized latent representation, which indicates the number of bits necessary to represent the encoded symbols, for example, bits-per-pixel (bpp);
a sparsification loss, for example, a loss that encourages the output of the Encoder NN or the output of the quantization to have many zeros. Examples are L0 norm, L1 norm, L1 norm divided by L2 norm; and
a cross-entropy loss applied to the output of a probability model, where the probability model may be a NN used to estimate the probability of the next symbol to be encoded by the arithmetic encoder 1005.

A similar training loss may be used for training the systems illustrated in FIG. 8 and FIG. 9.

For training one or more neural networks that are part of a codec, such as one or more neural networks in FIG. 8 and/or FIG. 9, one or more of reconstruction losses may be used, and one or more of rate losses may be used. The loss terms may then be combined, for example, as a weighted sum to obtain the training objective function. Typically, the different loss terms are weighted using different weights, and these weights determine how the final system performs in terms of rate-distortion loss. For example, when more weight is given to one or more of the reconstruction losses with respect to the rate losses, the system may learn to compress less but to reconstruct with higher accuracy as measured by a metric that correlates with the reconstruction losses. These weights are usually considered to be hyper-parameters of the training session and may be set manually by the operator designing the training session, or automatically, for example, by grid search or by using additional neural networks.

In one example embodiment, the rate loss and the reconstruction loss may be minimized jointly at each iteration. In another example embodiment, the rate loss and the reconstruction loss may be minimized alternately, e.g., in one iteration the rate loss is minimized and in the next iteration the reconstruction loss is minimized, and so on. In yet another example embodiment, the rate loss and the reconstruction loss may be minimized sequentially, e.g., first one of the two losses is minimized for a certain number of iterations, and then the other loss is minimized for another number of iterations. These different ways of minimizing rate loss and reconstruction loss may also be combined.

It is to be understood that even in end-to-end learned approaches, there may be components which are not learned from data, such as an arithmetic codec.

For lossless video/image compression, the system 1000 contains the probability model 1003, the arithmetic encoder 1005 and the arithmetic decoder 1006. The system loss function contains the rate loss, since the distortion loss is always zero, in other words, no loss of information.

### Video Coding for Machines (VCM)

Reducing the distortion in image and video compression is often intended to increase human perceptual quality, as humans are considered to be the end users, e.g., consuming or watching the decoded images or videos. Recently, with the advent of machine learning, especially deep learning, there is a rising number of machines (e.g., autonomous agents) that analyze or process data independently from humans and may even take decisions based on the analysis results without human intervention. Examples of such analysis are object detection, scene classification, semantic segmentation, video event detection, anomaly detection, pedestrian tracking, and the like. Example use cases and applications are self-driving cars, video surveillance cameras and public safety, smart sensor networks, smart TV and smart advertisement, person re-identification, smart traffic monitoring, drones, and the like. Accordingly, when decoded data is consumed by machines, a quality metric for the decoded data may be defined, which is different from a quality metric for human perceptual quality. Also, dedicated algorithms for compressing and decompressing data for machine consumption may be different than those for compressing and decompressing data for human consumption. The set of tools and concepts for compressing and decompressing data for machine consumption is referred to here as Video Coding for Machines.

The decoder-side device may have multiple ‘machines’ or neural networks (NNs) for analyzing or processing decoded data. These multiple machines may be used in a certain combination which is, for example, determined by an orchestrator sub-system. The multiple machines may be used, for example, in temporal succession, based on the output of the previously used machine, and/or in parallel. For example, a video which was compressed and then decompressed may be analyzed by one machine (NN) for detecting pedestrians, by another machine (another NN) for detecting cars, and by another machine (another NN) for estimating the depth of objects in the frames.

An ‘encoder-side device’ may encode input data, such as a video, into a bitstream which represents compressed data. The bitstream is provided to a ‘decoder-side device’. The term ‘receiver-side’ or ‘decoder-side’ refers to a physical or abstract entity or device which performs decoding of compressed data, and the decoded data may be input to one or more machines, circuits or algorithms.

The encoded video data may be stored into a memory device, for example, as a file. The stored file may later be provided to another device.

Alternatively, the encoded video data may be streamed from one device to another.

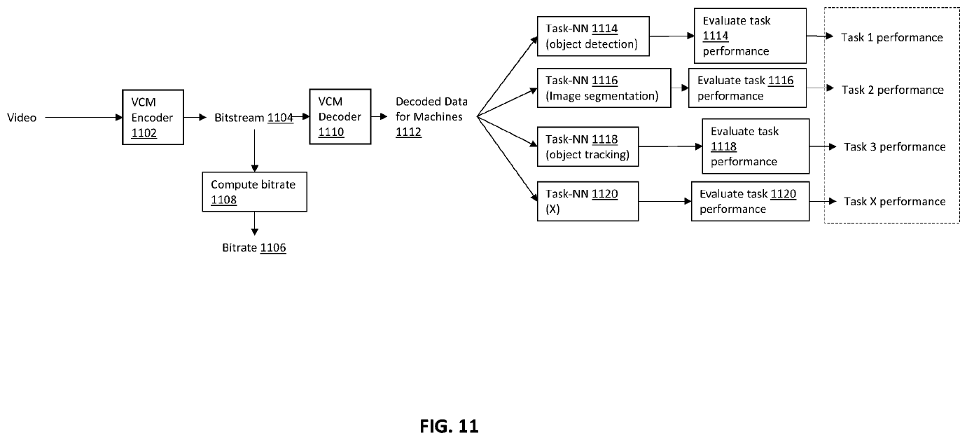

FIG. 11 illustrates a pipeline of video coding for machines (VCM), in accordance of an embodiment. A VCM encoder 1102 encodes the input video into a bitstream 1104. A bitrate 1106 may be computed 1108 from the bitstream 1104 in order to evaluate the size of the bitstream 1104. A VCM decoder 1110 decodes the bitstream 1104 output by the VCM encoder 1102. An output of the VCM decoder 1110 may be referred, for example, as decoded data for machines 1112. This data may be considered as the decoded or reconstructed video. However, in some implementations of the pipeline of VCM, the decoded data for machines 1112 may not have same or similar characteristics as the original video which was input to the VCM encoder 1102. For example, this data may not be easily understandable by a human, when the human watches the decoded video from a suitable output device such as a display. The output of the VCM decoder 1110 is then input to one or more task neural network (task-NNs). For the sake of illustration, FIG. 11 is shown to include three example task-NNs, a task-NN 1114 for object detection, a task-NN 1116 for image segmentation, a task-NN 1118 for object tracking, and a non-specified one, a task-NN 1120 for performing task X. The goal of VCM is to obtain a low bitrate while guaranteeing that the task-NNs still perform well in terms of the evaluation metric associated to each task.

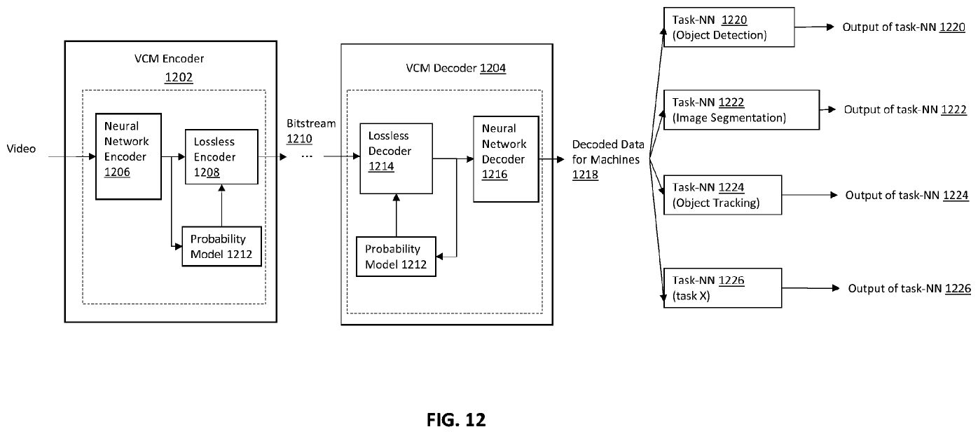

One of the possible approaches to realize video coding for machines is an end-to-end learned approach. FIG. 12 illustrates an example of an end-to-end learned approach, in accordance with an embodiment. In this approach, a VCM encoder 1202 and a VCM decoder 1204 mainly consist of neural networks. The video is input to a neural network encoder 1206. The output of the neural network encoder 1206 is input to a lossless encoder 1208, such as an arithmetic encoder, which outputs a bitstream 1210. The lossless codec may take an additional input from a probability model 1212, both in the lossless encoder 1208 and in a lossless decoder 1214, which predicts the probability of the next symbol to be encoded and decoded. The probability model 1212 may also be learned, for example, it may be a neural network. At a decoder-side, the bitstream 1210 is input to the lossless decoder 1214, such as an arithmetic decoder, whose output is input to a neural network decoder 1216. The output of the neural network decoder 1216 is a decoded data for machines 1218, that may be input to one or more task-NNs, e.g., a task-NN 1220 for object detection, a task-NN 1222 for object segmentation, a task-NN 1224 for object tracking, and a non-specified one, a task-NN 1226 for performing task X.

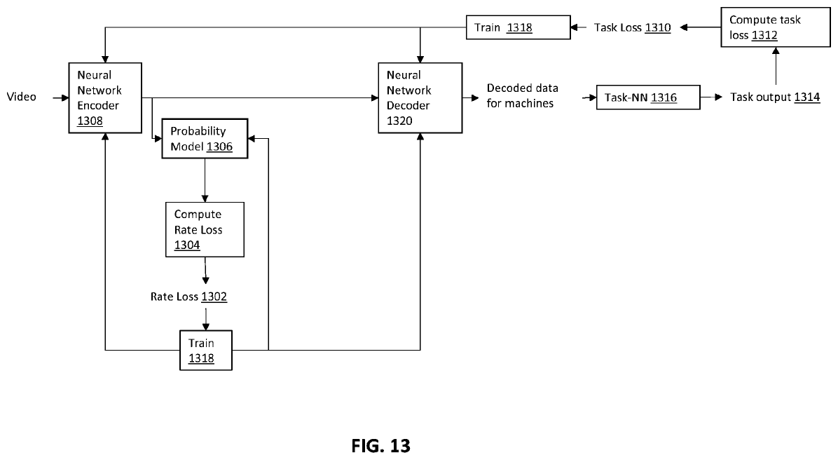

FIG. 13 illustrates an example of how the end-to-end learned system may be trained, in accordance with an embodiment. For the sake of simplicity, this embodiment is explained with help of one task-NN. However, it may be understood that multiple task-NNs may be similarly used in the training process. A rate loss 1302 may be computed 1304 from the output of a probability model 1306. The rate loss 1302 provides an approximation of the bitrate required to encode the input video data, for example, by a neural network encoder 1308. A task loss 1310 may be computed 1312 from a task output 1314 of a task-NN 1316.

The rate loss 1302 and the task loss 1310 may then be used to train 1318 the neural networks used in the system, such as the neural network encoder 1308, a probability model, a neural network decoder 1320. Training may be performed by first computing gradients of each loss with respect to the trainable parameters of the neural networks that are contributing or affecting the computation of that loss. The gradients are then used by an optimization method, such as Adam, for updating the trainable parameters of the neural networks.

Another possible approach to realize video coding for machines is to use a video codec which is mainly based on traditional components, that is components which are not obtained or derived by machine learning means. For example, H.266/VVC codec can be used. However, some of the components of such a codec may still be obtained or derived by machine learning means. In one example, one or more of the in-loop filters of the video codec may be a neural network. In another example, a neural network may be used as a post-processing operation (out-of-loop). A neural network filter or other type of filter may be used in-loop or out-of-loop for adapting the reconstructed or decoded frames in order to improve the performance or accuracy of one or more machine neural networks.

In some implementations, machine tasks may be performed at decoder side (instead of at encoder side). Some reasons for performing machine tasks at decoder side include, for example, the encoder-side device may not have the capabilities (computational, power, memory, and the like) for running the neural networks that perform these tasks, or some aspects or the performance of the task neural networks may have changed or improved by the time that the decoder-side device needs the tasks results (e.g., different or additional semantic classes, better neural network architecture). Also, there could be a customization need, where different clients would run different neural networks for performing these machine learning tasks.

At encoding phase, when an input content needs to be encoded (e.g., an input image or a video sequence), the encoder may decide to optimize some of the parameters of the neural network with respect to the specific input content. In some proposed embodiments, the terms ‘optimize’, ‘adapt’, ‘finetune’, and ‘overfit’ the parameters may refer to the same operation, e.g., making the parameters more optimal to the input content, in order to improve the rate-distortion performance or to minimize the distortion or to minimize the rate. The parameters to be adapted may belong to, but are not limited to, one or more of the following categories of parameters:
The encoder's trainable parameters or weights;
The output of the encoder, e.g., the latent tensor;
The probability model's trainable parameters or weights;
The decoder's trainable parameters or weights; for example, the parameters of an in-loop neural network filter; or
The post-processing trainable parameters, for example, the parameters of one or more post-processing neural network filters.

In an embodiment, the parameters to be adapted may be a subset of one or more of the above categories of parameters. For example, they could be the bias terms of an in-loop neural network filter, or the trainable parameters of the last convolutional layer of a post-processing neural network filter.

In an embodiment, the optimization or finetuning may be performed at encoder-side, and may comprise an iterative process, where at each iteration a loss function is computed by using one or more outputs of the codec, the loss function is differentiated with respect to the parameters to be optimized in order to compute gradients (for example, one gradient for each parameter to be optimized), the computed gradients are then used for updating the parameters to be optimized, for example, by using an optimizer routine such as stochastic gradient descent (SGD) or Adam. The neural network, whose parameters represent the initial parameters which are then finetuned by the finetuning process, may be referred to as the base model or base neural network in some of the embodiments. The finetuning process may be performed until one or more criteria are met. One example criterion may be a predetermined number of iterations. Another example criterion may be a predetermined distortion value, a predetermined rate, or a predetermined rate-distortion performance. Yet another example criterion may be a predetermined time elapsed from the beginning of finetuning. Still another example criterion may be a loss term value or the loss function value not changing more than a predetermined amount for a predetermined number of iterations. After a neural network has been finetuned, it is possible to compute a weight-update, which may be the difference between one or more parameters of the neural network before the finetuning process and the corresponding one or more parameters of the neural network after the finetuning process. Alternatively, the weight-update may be the difference between one or more parameters of the neural network after the finetuning process and the corresponding one or more parameters of the neural network before the finetuning process.

Some examples of loss function, include, but are not limited to:
A distortion, such as a mean squared error (MSE) or the multi-scale structural similarity (MS-SSIM), computed between the final reconstructed output and the uncompressed data; and
A rate loss, which may be an estimation of the rate or bitrate necessary to represent the bitstream output by the encoder. In one example, the rate estimation may be derived from the output of a probability model, where the probability model may be a neural network.

The one or more outputs from the codec, that may be used to compute the loss terms may be:
The output of the decoder;
The output of any post-processing operations performed on the output of the decoder. For example, the output of one or more post-processing neural networks; or
The output of a rate estimation module, such as a probability model.

As an example, various embodiments consider the case of finetuning a post-processing filter, which is applied on the output frames from the decoder, e.g., VVC/H.266 decoder.

It may be noted that:
the finetuning may be applied to other learnable components of the codec;
the decoder may be any other decoder, such as a non-learned decoder, partially-learned decoder (e.g., incorporating a NN in-loop filter), a fully learned decoder;
data other than video data may be considered, e.g., an image or audio data.

An embodiment proposes to finetune a neural network, where the initial parameters of the neural network to be finetuned may be one or more parameters of one or more base neural networks, or base NNs. Some examples of base NNs are the following:
A randomly initialized NN;
A NN which was trained on a set of videos, where the set may include the current input video;
A NN which was trained or finetuned on the whole one video, which may be the current input video;
A NN which was trained or finetuned on one or more sets of consecutive frames of one or more videos, where the one or more video may include the current input video;
A NN which was trained or finetuned on one or more frames of one or more videos, where the one or more videos may include the current input video; and/or
A NN which was trained or finetuned on one of more patches of one frame or more frames of one or more videos, where the one or more videos may include the current input video.

The finetuning may be performed for different parts or portions of the NN by using parameters of different base neural networks as the initial parameters. For example, in an instance where the NN comprises a first layer and a second layer, the parameters of a first layer may be finetuned by using the corresponding parameters of a first base neural network as the initial parameters, and the parameters of a second layer may be finetuned by using the corresponding parameters of a second base neural network as the initial parameters.

Information about which base NNs a decoder side needs to use for obtaining an updated NN, for a certain media element, may be signaled from an encoder side to a decoder side in or along a video bitstream. For example, the encoder side may signal to the decoder side that, for a certain frame (e.g., with ID frame_id=FRAME_ID1), an updated post-processing neural network may be obtained by updating a certain layer (e.g., with ID layer_id=LAYER_ID1) of a certain base NN (e.g., with ID base_id=BASE_ID1) by using a certain weight-update (e.g., with ID wu_id=WU_ID1), and by updating another layer (e.g., with ID layer_id=LAYER_ID2) of another base NN (e.g., with ID base_id=BASE_ID2) by using another weight-update (e.g., with ID wu_id=WU_ID2).

Information about which NN needs to be used for a certain sequence may be signaled from an encoder side to a decoder side in or along a video bitstream. For example, the information may indicate that a certain NN trained on a set of videos may be used for the whole video.

In an embodiment, the optimization may be performed at encoder-side, and may comprise computing a loss function using the output of the decoder, and differentiating it with respect to the parameters to be optimized.

In an example, in the case of optimizing the decoder's trainable parameters, a subset of those parameters may be trained. As the update needs to be signaled to the decoder-side, this may result in reducing the bitrate overhead.

Various embodiments enable determining, from point of view of rate-distortion optimization, a subset of parameters that are optimal to be adapted to the input content.

Some other embodiments describe designing additional parameters, with respect to standard neural networks, that provide a rate-distortion gain with respect to parameters of a standard neural network. Herein, a standard neural network refers to a neural network which does not include the additional parameters, e.g., a neural network which does not include scaling factors. Herein, standard parameters refer to parameters which are not the additional parameters, e.g., parameters which are not the scaling factors. In an embodiment, a standard neural network may be a building block for a complex neural network.

### Adapting Scaling Factors

Various embodiments propose techniques for adapting parameters of one or more decoder-side neural networks, at inference time (e.g., when the codec is used for compressing an input test image or video). Some examples of such decoder side neural networks may include, but are not limited to, following:
A NN post-processing filter, for either an end-to-end learned codec, or for a hybrid (non-learned codec+one or more learned NN tools), or for a completely non-learned codec;
A NN in-loop filter, for an end-to-end learned codec, or for a hybrid (non-learned codec+one or more learned NN tools, where one of the learned NN tools is the NN in-loop filter);
A learned probability model that is used for lossless coding, for an end-to-end learned codec, or a hybrid (non-learned codec+one or more learned NN tools, where one of the learned NN tools is the learned probability model); and
A decoder neural network for an end-to-end learned codec.

It is to be understood the some of the embodiments herein may be applied also to one or more encoder-side neural networks.

Various embodiments propose to use a set of additional learnable parameters for a decoder-side neural network, with respect to standard learnable parameters (e.g., parameters which are commonly included into current-state neural networks). This new set of additional learnable parameters may be included into the computational graph of the neural network, and this may be done either before training the other learnable parameters of the NN, or after training the other learnable parameters of the NN.

The additional learnable parameters may comprise scaling factors which modulate (multiply) the output of one or more layers of the neural network. Examples of the modulation operator include, but are not limited to, multiplication (intensify or attenuate), addition (offset), or a combination thereof.

In one example, there may be one scaling factor for each convolutional kernel of one or more convolutional layers of a neural network. In another example, there may be one scaling factor for all the convolutional kernels of one or more convolutional layers of a neural network.

### Initialization of Scaling Factors

Initially (e.g., before the inference phase), one or more of the scaling factors in the decoder-side neural network may have the following values:
1;
Values determined based on a random initialization; or
Values determined via a training procedure. For example, values determined by training the scaling factors jointly with all other learnable parameters. In this example, the initial values of the scaling factors may be the values of the scaling factors in the one or more base neural networks which are used as the starting point for the finetuning process.

In an embodiment, a combination of the above types of initializations may be possible. For example, the scaling factors for one or more convolutional layers may be all 1, and the scaling factors for the remaining convolutional layers may be determined via a training procedure.

### Compression of the Adapted Parameters or of the Adaptation

The adapted scaling factors or the adaptation of the scaling factors (e.g., the computed weight-update) may be compressed by one or more of the following example methods:
Quantization, e.g., converting the adapted scaling factors or the update to the scaling factors from floating-point 32 bits to fixed precision 8 bits;
Sparsification, e.g., by setting to zero the values when the corresponding absolute values are below a predetermined threshold;
Sparsification around one, e.g., by sparsifying the values of the scaling factors minus one;
Predictive coding, where the decoder-side device may predict the weight-updates, and the encoder may signal only a residual (e.g., the prediction error). This prediction error may further be compressed by quantization and entropy coding;
Lossless coding; or
Other suitable mechanisms.
   Additional Example Embodiment: Adapting Other Parameters than Scaling Factors

In an additional embodiment, the parameters to be adapted may be additive factors, such as the bias terms of the convolutional layers and the bias terms of the fully-connected layers.

### Example Information and Assumptions

Various embodiments consider the examples of compressing and decompressing data. For the sake of simplicity, in various embodiments, video is considered as an example of data type. However, it should be noted that the embodiments are also applicable to other data types, e.g., image or audio data.

In some embodiments, it is assumed that an encoder-side device performs a compression or encoding operation by using an encoder. A decoder-side device performs decompression or decoding operation by using a decoder. The encoder-side device may also use some decoding operations, for example, in a coding loop. The encoder-side device and the decoder-side device may be the same physical device, or different physical devices.

In some embodiments, it is assumed that the decoder contains one or more neural networks. Some examples of such decoder side neural networks may include the following:
A NN post-processing filter, for either an end-to-end learned codec, or for a hybrid codec (a non-learned codec that incorporates one or more learned NN tools), or for a completely non-learned codec. Examples of possible types of post-processing are enhancement of visual quality for humans, enhancement of visual quality for machine analysis or processing, super-resolution, denoising, application of visual effects;
A NN in-loop filter, for an end-to-end learned codec, or for a hybrid codec (a non-learned codec that incorporates one or more learned NN tools, where one of the learned NN tools is the NN in-loop filter);
A NN that performs intra-frame prediction;
A NN that performs inter-frame prediction;
A NN that performs inverse transform;
A learned probability model that is used for estimating a probability, where the probability is used by a lossless decoder such as an arithmetic decoder. The learned probability model may be part of an end-to-end learned codec, or part of a hybrid codec (a non-learned codec that incorporates one or more learned NN tools, where one of the learned NN tools includes the learned probability model); or
A decoder neural network for an end-to-end learned codec.

### Terminology: Encoder, Encoder-Side, Decoder, Decoder-Side

In various embodiments, the difference between decoder and decoder-side is that the decoder comprises operations which are necessary to decode the encoded data, whereas the decoder-side comprises the decoder and any additional operations which are optional to decode the encoded data. The additional operations performed at decoder-side may include enhancing some features of the decoded data. For example, an additional operation may be a post-processing filter which enhances the visual quality (for example, according to an objective quality metric such as peak signal-to-noise ratio (PSNR)), where this post-processing filter may not be part of the decoder, but may be part of the decoder-side.

Similarly, the difference between encoder and encoder-side is that the encoder comprises operations which are necessary to encode an input data, the encoder-side may include the encoder and any additional operations which are optional to encode the input data. The additional operations performed at encoder-side may include enhancing or optimizing some aspects of the encoded data.

It is to be understood that in the context of data compression (including compression of images and videos), the encoder may include one or more operations performed by the decoder. In some cases, the encoder or encoder-side may perform one or more operations performed by the decoder or decoder-side.

### Information on Model Finetuning at Inference Time

At the encoding phase, in an instance an input content needs to be encoded (such as an input image or video sequence), the encoder may decide to optimize some of the parameters of the neural network with respect to the specific input content. In various embodiments, the terms ‘optimize’, ‘adapt’, ‘finetune’, and ‘overfit’ the parameters may refer to the same operation, e.g., making the parameters more optimal to the input content, in order to improve the rate-distortion performance or to minimize the distortion or to minimize the rate. The parameters to be adapted may belong to one or more of the following categories of parameters:
The encoder's trainable parameters or weights;
The output of the encoder, e.g., the latent tensor;
The probability model's trainable parameters or weights;
The decoder's trainable parameters or weights. For example, the parameters of an in-loop neural network filter; and/or
The post-processing trainable parameters. For example, the parameters of one or more post-processing neural network filters.

In particular, the parameters to be adapted may be a subset of one or more of the above categories of parameters. For example, they could be a subset of the decoder's trainable parameters or weights, or a subset of a post-processing neural network filter.

The optimization may be performed at encoder-side and may comprise computing a loss function using one or more outputs from the codec, and differentiating it with respect to the parameters to be optimized.

Some example of loss functions include following:
A distortion, such as the Mean squared error (MSE) or the Multi-Scale Structural Similarity (MS-SSIM), computed between the final reconstructed output and the uncompressed data; and
A rate loss, such as the output of a probability model, where the probability model may be a neural network.

The one or more outputs from the codec, that can be used to compute the loss terms may be:
The output of the decoder;
The output of any post-processing operations performed on the output of the decoder. For example, the output of one or more post-processing neural networks; and
The output of a rate estimation module, such as a probability model.

After the model finetuning, the weight updates are calculated as the difference between the updated parameter values and the original parameter values. The weight updates of the decoder parameters may be quantized and compressed before sending to the decoder. At the decoding stage, the decoder first decodes the weight updates from the bitstream and adapts the model parameters accordingly. Then, the updated decoder model is used to decode the rest of the bitstream to reconstruct the input content.

Neural networks normally include a large number of trainable parameters. Since the weight updates for the decoder parameters are included in the bitstream, the compression of the weight updates is important to reduce the total size of the bitstream and achieve a better rate-distortion performance.

Various embodiments propose methods to compress the weight updates more efficiently. The proposed embodiments may be used for any neural network-based video or image coding approach, including but not limited to, those described in the above sections. For example, various embodiments may be used in the case where NNs are used to replace one or more of the components of a traditional video/image codec or in an auto-encoder approach.

Furthermore, various embodiments may be utilized in any information compression process where the representation of information is parametrized (e.g., a trained neural network or a graph model where weights are assigned to nodes) and where parameters can be updated via a communication channel or network in an incremental manner.

Various methods have been proposed to compress weight updates for the model finetuning technique. One such method proposes to apply a loss term (ratio of L1 norm over L2 norm, where L1 norm and L2 norm are computed based on at least some of the weight update values) that promotes sparsity during model finetuning stage to achieve compressible weight updates. Another method proposes to jointly finetune the latent tensor and the decoder parameters. To compress the weight updates, a predefined spike-and-slab prior model is used during the model finetuning. These approaches assume the parameters are equally important for model finetuning. By generating sparse weight updates at the model finetuning stage, compression is achieved. However, extra bits are still required in the bitstream for the parameters even when their weight update values are zeros, i.e., the parameters have not been updated. Yet another method suggests that the bias parameters are more important than other parameters for model finetuning. By finetuning only the bias parameters, the bitstream overheads are greatly reduced and a significant performance gain is achieved compared to using a pretraining and non-finetuned neural network.

Although the number of bias parameters is much smaller compared to the total number of parameters, the bitstream overheads still significantly and greatly diminish the gains achieved by model finetuning. Meanwhile, some non-bias parameters may also be important for the model to adapt to the input content.

Various embodiments propose different methods to compress the weight updates, thus, reducing the bitstream overheads because of the model finetuning.

In one embodiment, an importance or priority mask (may be simply referred to as importance mask), indicating the importance or priority (may be simply referred to as importance) of the parameters for model finetuning, is learned using a training dataset. The importance mask is shared by the encoder and the decoder. At the model finetuning stage, the important parameters are finetuned by the encoder and the corresponding weight updates are sent to the decoder. The decoder can reconstruct the weight updates from the bitstream and update the corresponding parameters in the model according to the importance mask.

In another embodiment, an importance ordering list, indicating the order of importance of the parameters in the decoder, is learned using a training dataset. The importance ordering list is shared by the encoder and decoder. The encoder may send or signal a number of the parameters that are updated at the model finetuning and the corresponding weight updates to the decoder. In some embodiments, the number of the parameters indicates a total number of the parameters that are updated at the model finetuning. Some examples of the number of the parameters may include, but are not limited to, an integer, a positive integer, a natural number. For example, in an instance there are 1000 parameters that are updated at the model finetuning, the number of parameters include 1000. Accordingly, the encoder signals 1000 as the number or the total number of the parameters that are updated at the model finetuning. The decoder may recover the weight updates from the bitstream using the received number of parameters and the importance ordering list. In one example, the importance ordering list may be divided into groups of consecutive ordered parameters (e.g., into 4 groups), and the encoder may signal an indication to indicate one or more groups that have been updated. In this example, in an instance, the encoder signals that only a first group has been updated, the decoder may use the weight update received from the encoder to update the parameters that are included into the first group within the importance ordered list.

Yet in another embodiment, the encoder and decoder share multiple importance masks and/or ordering lists. The encoder determines the importance mask or importance ordering list that is to be used by the decoder during the model finetuning stage. The selected mask or ordering list is signaled to the decoder. The encoder can also send one or more new importance masks or one or more ordering lists to the decoder after the model finetuning. The decoder may adapt the model parameters using the received weight updates according to the received importance mask or ordering list.

### Importance Mask and Importance Ordering List

Parameters of a deep neural network are highly redundant and the importance of each parameter in a model is different. Some parameters have a larger impact on the system performance when the model finetuning is performed as compared to other parameters. Various embodiments propose that a subset of parameters, e.g., named or identified as important parameters, are finetuned by the encoder at the model finetuning stage. The weight updates of the important parameters are sent from the encoder to the decoder. Thus, the bitstream overheads required to encode the weight updates may be significantly reduced.

In this regards, an importance mask is a binary mask that indicates the important parameters among the fine-tunable parameters on the decoder side, and an importance ordering list is a list indicating the order of the importance of each fine-tunable parameter on the decoder side.

The importance mask and the importance ordering list may be learned using a training dataset. Given a pretrained NN-based video coding model, let 0 be the parameters at the decoder side that may be finetuned at the finetuning stage. Let training dataset be D, which contains N training samples x₁, x₂, . . . , x_{N}, the importance mask or importance ordering list can be learned with the steps as follows.

Minimize the objective function with a proper loss term, for example, with additional L1 loss term

$$J = \frac{1}{N} {\sum }_{i = 1}^{N} [ p ( {x}_{i} ; θ + {ϕ}_{i} ) + λ {‖ {ϕ}_{i} ‖}_{1} ] , \qquad equation [ 1 ]$$

where ϕᵢ is the weight update of parameter θ for sample xᵢ, p(xᵢ; θ+ϕᵢ) is a rate distortion (RD) loss of the system for sample xᵢ with the weight update, ∥.∥₁ stands for L1 norm, and λ is the weight parameter to control the sparsity.

Another example of objective function is to use group sparsity loss term such as:

$$J = \frac{1}{N} {\sum }_{i = 1}^{N} [ p ( {x}_{i} ; θ + {ϕ}_{i} ) ] + λ {\sum }_{j = 1}^{M} {‖ {ϕ}_{* , j} ‖}_{2} \qquad equation [ 2 ]$$

where M is the number of parameters in θ, ϕ_{.,j}=[+ϕ_{1,j}, ϕ_{2,j}, . . . ϕ_{N,j}]^{T} is the vector of weight updates of all training samples for parameter j, and ∥.∥₂ stands for Euclidean norm.

The objective function can be minimized using any optimization methods, such as stochastic gradient descent (SGD).

After the objective function, for example, Equation 1 or 2, are minimized with regards to ϕ, the importance score of each parameter can be determined.

With the importance scores for the parameters, an importance mask may be derived using a threshold value. The threshold value may be determined from the training dataset by optimizing the average RD loss of the samples in the training dataset. An importance ordering list may be derived by sorting the parameters by their importance scores.

In one embodiment, the importance score of a parameter is a sum of the absolute values of the weight updates on this parameter for the samples in the training dataset.

In another embodiment, the importance score of a parameter is the sum of the absolute value of the ratio of the weight update value over the original weight value on this parameter for the samples in the training dataset, where the original weight value of a parameter may be the value of the parameter before finetuning.

In yet another embodiment, the importance score of a parameter may be obtained using an importance metric, examples of such metrics may be the sum of absolute values, graph diffusion-based approaches, saliency techniques such as absolute value differences, the amount of change in the gradient and hessian change during training process, and the like. In an embodiment, the importance may be calculated using a combination of such metrics. The metrics could be calculated locally, e.g., in a predetermined neighborhood, or globally.

In yet another embodiment, the importance score may be a combination of the importance metric and a learned importance. Such combination may be achieved using summation or multiplication or linear combination of scores. A nonlinear combination is also possible through a learning-based approach via a linear or non-linear combination which could include neural networks or any computational technique.

In another embodiment, importance score of a parameter may be provided by other means or other external processing systems which run a specific metric determination process and then provide the results for further processing.

### Single Importance Mask

In one embodiment, an importance mask is learned using one of the afore-mentioned methods and shared between the encoder and the decoder. At the model finetuning stage, the encoder finetunes the important parameters of the decoder according to the importance mask. Then the weight updates of the important parameters are collected after the model finetuning. Quantization and further compression may be applied to the weight updates to further reduce the size of the bitstream. The uncompressed/quantized/compressed weight updates are then sent to the decoder.

The decoder reconstructs the weight updates from the bitstream. Decompression and dequantization may be applied when required. Then, the decoder updates the corresponding parameters in the model according to the importance mask.

### Single Importance Ordering List

In another embodiment, an importance ordering list is learned using one of the afore-mentioned methods and shared between the encoder and decoder. At the model finetuning stage, the encoder finetunes the parameters of the decoder and determines the number of important parameters that should be included in the weight updates.

Given a pre-trained video coding model and an importance ordering list, an example of a model finetuning strategy that simultaneously and significantly simultaneously finds an optimal number of important parameters and the corresponding weight updates is as follows:
Perform model finetuning by selecting a large number of important parameters according to the importance ordering list. Save the finetuned model. Calculate the RD loss value including the weight update overheads.
Remove a certain number of least import parameters from the already selected important parameters and continue the model finetuning from the current finetuned model. Save the finetuned model and calculate the RD loss value including the weight update overheads.
Repeat step 2, until a stopping criterion is met, for example, the best performance is found, or the number of selected parameters reaches a predefined threshold value.

Another example of a model finetuning strategy that, simultaneously or substantially simultaneously, finds the optimal number of important parameters and the corresponding weight updates is to apply the golden-section search technique.

After the optimal number of important parameters the corresponding weight updates are determined, the encoder sends the number of important parameters together with the weight updates to the decoder. The weight updates may be quantized and/or compressed to further reduce the size of the bitstream.

At the decoding phase, the decoder first reconstructs the number of parameters and the weight updates from the bitstream. Decompression and dequantization may be applied when required. Then, the decoder updates the corresponding parameters in the model according to the importance ordering list.

### Multiple Importance Masks and Importance Ordering Lists

Multiple importance masks and importance ordering lists may be learned from the training dataset. The training dataset may be divided into multiple subsets and each subset is used to learn an importance mask or importance ordering list. The dividing may be performed according to the similarity of the content, or the similarity of the important parameters according to a pre-trained model.

In one embodiment, the encoder determines the optimal importance mask among all available importance masks and the corresponding weight updates at the model finetuning stage. The weight updates may be quantized and/or further compressed to reduce the size of the bitstream. The index of the optimal importance masks the weight updates are sent to the decoder. At the decoding phase, the decoder first reconstructs the index of the optimal importance mask and the weight updates from the bitstream. Decompression and dequantization may be applied when required. Then, the decoder updates the corresponding parameters in the model according to the selected importance mask.

In another embodiment, the encoder determines the optimal importance ordering list among all available importance ordering lists, the optimal number of important parameters, and the corresponding weight updates at the model finetuning stage. The weight updates may be quantized and/or further compressed to reduce the size of the bitstream. The index of the optimal importance ordering list, the optimal number of important parameters, and the weight updates are sent to the decoder. At the decoding phase, the decoder first reconstructs the index of the optimal importance ordering list, the number of important parameters, and the weight updates from the bitstream. Decompression and dequantization may be applied when required. Then, the decoder updates the corresponding parameters in the model according to the selected importance ordering list and the number of important parameters.

In yet another embodiment, the encoder may learn one or more important masks or importance ordering lists from the input content and send the learned one or more importance masks or importance ordering lists to the decoder. For example, when compressing a video sequence, the encoder may first learn one or more importance masks or one or more importance ordering lists from the video sequence or a segment of the video sequence. The leaned one or more importance masks or ordering lists are then transferred to the decoder. Then, the encoder performs model finetuning when compressing the frames or video segments according to the learned importance masks or importance ordering lists.

### Carriage of Importance Mask:

The importance mask may be transferred in compressed form or uncompressed form. A flag may indicate the compression of the importance mask, for example, in an instance it is not already known at decoder side.

Different compression algorithms and encoding mechanisms could apply, a flag may indicate the compression algorithm for invoking the proper decoding procedure.

On Sharing the Importance Mask(s) and/or Importance Ordering List(s)

As described above one or more importance mask(s) and/or importance ordering list(s) are shared by the encoder and the decoder. Methods for sharing may include, but are not limited to, one or more of the following:
Pre-defining importance mask(s) and/or importance ordering list(s) e.g., in a coding standard;
Pre-defining importance mask(s) and/or importance ordering list(s), pre-defining a unique identifier, such as a unique resource name (URN), for each importance mask or importance ordering list, and indicating the used unique identifier(s) of the importance mask(s) and/or importance ordering list(s) in or along the video/image bitstream from the encoder to the decoder;
Delivering importance mask(s) and/or importance ordering list(s) in or along the video/image bitstream;
Delivering importance mask(s) and/or importance ordering list(s) at a session setup, e.g., as a part of media presentation description; or
Delivering importance mask(s) and/or importance ordering list(s) from the encoder to the decoder prior to or during video/image bitstream delivery.

In another embodiment, the above-mentioned methods are applicable to any information-bearing bitstream and not limited to video/image (e.g., applicable to audio or any other media type or any N-dimensional signal)

### Gradual Finetuning

In an embodiment, an encoder may perform the following:
select a first number of parameters to be updated for a first unit of the video/image bitstream, such as a first coded picture. The weight updates may be derived by using any of the described embodiments. The weight updates may be quantized and/or compressed to further reduce the size of the bitstream;
signal to the decoder the first number of parameters and the respective weight updates with the first unit of the video/image bitstream;
use the updated neural network for encoding the first unit of the video/image bitstream;
select a second number of parameters to be updated for a second unit of the video/image bitstream, such as a second coded picture, where the second unit follows the first unit in the bitstream order and the second number of parameters follow the first number of parameters in the importance ordering list. The weight updates may be derived by using any of the described embodiments. The weight updates may be quantized and/or compressed to further reduce the size of the bitstream;
signal to the decoder the second number of parameters and the respective updated parameters with the second unit of the first video/image bitstream; and
use the updated neural network for encoding the second unit of the video/image bitstream.

In an embodiment, a decoder may perform the following:
reconstruct the first number of parameters and the respective weight updates from the bitstream. Decompression and dequantization may be applied when required;
update the corresponding parameters in the model according to the importance ordering list;
use the updated neural network for decoding the first unit of the video/image bitstream;
reconstruct the second number of parameters and the respective weight updates from the bitstream. Decompression and dequantization may be applied when required;
update the corresponding parameters in the model according to the importance ordering list; and
use the updated neural network for decoding the second unit of the video/image bitstream.

In an embodiment, an encoder may perform the following:
select a first number of parameters to be updated for a first unit of the video/image bitstream, such as a first coded picture. The weight updates may be derived by using any of the described embodiments. The weight updates may be quantized and/or compressed to further reduce the size of the bitstream;
signal to the decoder the first number of parameters and the respective weight updates with the first unit of the video/image bitstream;
use the updated neural network for encoding the first unit of the video/image bitstream;
select a second number of parameters to be updated for a second unit of the video/image bitstream, such as a second coded picture, where the second unit follows the first unit in the bitstream order and the second number of parameters is equal to the first number of parameters. The weight updates may be derived by using any of the described embodiments. The weight updates may be quantized and/or compressed to further reduce the size of the bitstream;
signal to the decoder the updated parameters with the second unit of the first video/image bitstream and a flag indicating that the previous number of parameters may be used as the number of parameters for the current unit of the first video/image bitstream, e.g., the first number of parameters may be used as the number of parameters for the second unit of the first video/image bitstream; and
use the updated neural network for encoding the second unit of the video/image bitstream.

Various embodiments described herein are not limited to any specific method for deriving the first number of parameters and/or the second number of parameters. However, in one or more embodiments, an encoder selects the first number of parameters and/or the second number of parameters according to one or more of the following:
A bit budget for the updated parameters that may be determined e.g., by a bit rate control module of the encoder. A bit budget may be determined e.g., based on one or more of the following:
   Leftover bitrate in a previous unit of the video/image bitstream; e.g., when the target bitrate for the previous unit of video/image bitstream was A but it actually had bitrate B (where B<A), the bit budget may correspond to B−A; or
   Leftover size in video packets; in packet-oriented networks any packets up to the maximum transfer unit (MTU) size are generally treated equally. The bit budget may be determined to fill in a packet up to an MTU size when a unit of the video/image bitstream carried in the packet has size less than the MTU size.
A rate-distortion decision as described in any other embodiment but performed for the first unit and first number of parameters separately from the second unit and second number of parameters. The first unit and the second unit may, for example, selected to be a first coded picture and a second picture, respectively, or a first hierarchical prediction structure of pictures (a first “GOP”) and a second hierarchical prediction structure of pictures.

In an embodiment, an encoder determines and indicates or signals following in or along the video/image bitstream:
whether the second number of parameters follow the first number of parameters in the importance ordering list; or
whether the second number of parameters are related to the start of the importance ordering list.

In an embodiment, a decoder decodes following from or along the video/image bitstream:
whether the second number of parameters follow the first number of parameters in the importance ordering list; or
whether the second number of parameters are related to the start of the importance ordering list.

Thereafter, the decoder decodes the respective weight updates according to the indicated position in the importance ordering list.

### Example Experiments Results

In this section, illustrates the performance of the proposed methods on the lossless image compression codec. The system performance is measured by the average bits per pixel (BPP) on the validation set. The training and validation dataset is collected from the open images dataset.

Two importance masks are learned using the objective function specified in the equations 1 and 2 respectively. The number of important parameters is set to 500. The baseline for comparing the proposed method is the system that finetunes the first 500 bias parameters of the convolutional layers that are close to the output. The average BPP for the 500 randomly selected validation images using a pre-trained model is 7.80. BPP, after model finetuning, may be calculated from the total size of the bitstream that includes the content bitstream and the weight update overhead, e.g., the total size of the bitstream in bits divided by the number of the pixels. BPP saving is the difference of the pretrained model and the BPP after model finetuning. The larger BPP saving, the better codec performs. The following table shows average BPP and BPP savings after the model finetuning.

| | BPP after | BPP |
|---|---|---|
| Model | model finetuning | saving |
| Bias baseline | 7.772 | 0.0281 |
| L1 loss (Eq. 1) | 7.708 | 0.092 |
| Group sparsity loss (Eq. 2) | 7.699 | 0.101 |

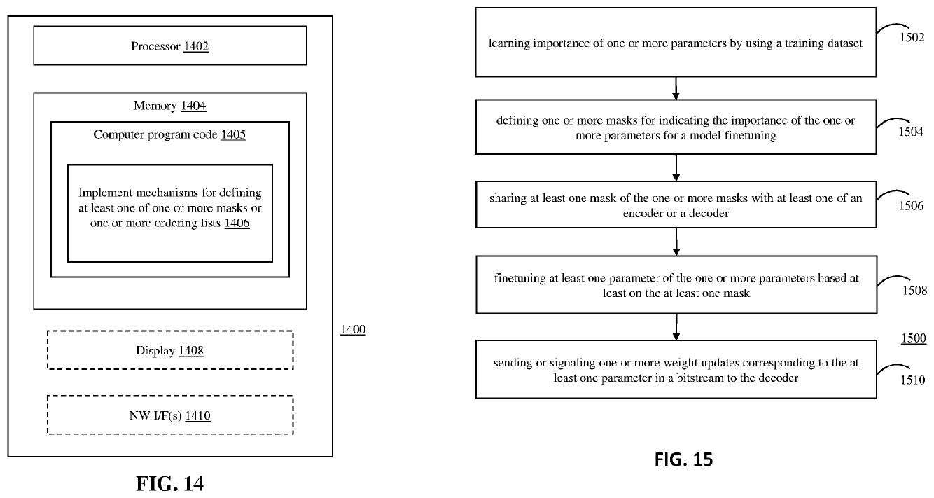

FIG. 14 is an example apparatus 1400, which may be implemented in hardware, configured to implement mechanisms for defining at least one of one or more masks or one or more ordering lists, based on the examples described herein. The apparatus 1400 comprises at least one processor 1402, at least one non-transitory memory 1404 including computer program code 1405, wherein the at least one memory 1404 and the computer program code 1405 are configured to, with the at least one processor 1402, cause the apparatus 1400 to implement mechanisms for defining at least one of: one or more masks or one or more ordering lists 1406, based on the examples described herein. In an embodiment, the one or more masks or the one or more ordering lists are defined for at least one neural network (NN) or a portion of the at least one NN. In an embodiment, the at least one neural network or the portion of the at least one neural network may be used at a decoder-side for decoding or reconstructing one or more media items. In another embodiment, the at least one neural network or the portion of the at least one neural network may be used at an encoder-side for encoding one or more items.

The apparatus 1400 optionally includes a display 1408 that may be used to display content during rendering. The apparatus 1400 optionally includes one or more network (NW) interfaces (I/F(s)) 1410. The NW I/F(s) 1410 may be wired and/or wireless and communicate over the Internet/other network(s) via any communication technique. The NW I/F(s) 1410 may comprise one or more transmitters and one or more receivers. The N/W I/F(s) 1410 may comprise standard well-known components such as an amplifier, filter, frequency-converter, (de)modulator, and encoder/decoder circuitry(ies) and one or more antennas.

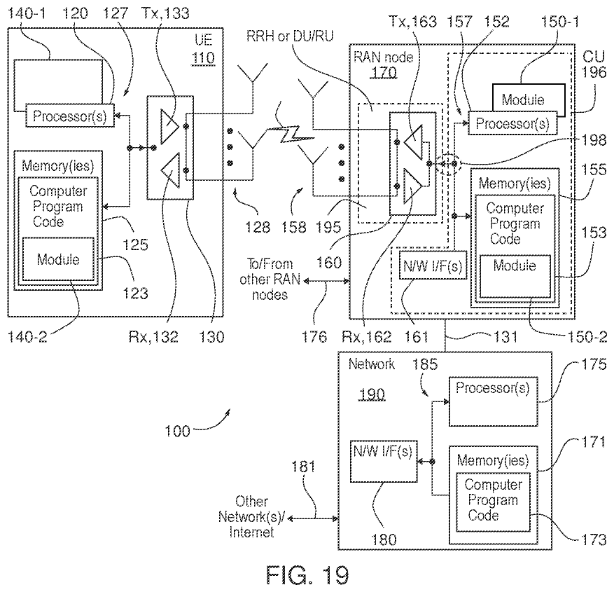

The apparatus 1400 may be a remote, virtual or cloud apparatus. The apparatus 1400 may be either a coder or a decoder, or both a coder and a decoder. The at least one memory 1404 may be implemented using any suitable data storage technology, such as semiconductor based memory devices, flash memory, magnetic memory devices and systems, optical memory devices and systems, fixed memory and removable memory. The at least one memory 1404 may comprise a database for storing data. The apparatus 1400 need not comprise each of the features mentioned, or may comprise other features as well. The apparatus 1400 may correspond to or be another embodiment of the apparatus 50 shown in FIG. 1 and FIG. 2, or any of the apparatuses shown in FIG. 3. The apparatus 1400 may correspond to or be another embodiment of the apparatuses shown in FIG. 19, including UE 110, RAN node 170, or network element(s) 190.

FIG. 15 illustrates an example method 1500 for defining one or more masks, in accordance with an embodiment. As shown in block 1406 of FIG. 14, the apparatus 1400 includes means, such as the processing circuitry 1402 or the like, for implementing mechanisms for defining one or more masks. At 1502, the method 1500 includes learning importance of one or more parameters by using a training dataset. At 1504, the method 1500 includes defining one or more masks for indicating the importance of the one or more parameters for a model finetuning. At 1506, the method 1500 includes sharing at least one mask of the one or more masks with at least one of an encoder or a decoder. At 1508, the method 1500 includes finetuning at least one parameter of the one or more parameters based at least on the at least one mask. At 1510, the method 1500 includes sending or signalling one or more weight updates corresponding to the at least one parameter in a bitstream to the decoder.

In an embodiment, the decoder reconstructs the one or more weight updates from the bitstream and updates one or more parameters corresponding to the one or more weight updates based on the at least one mask.

In an embodiment, the method 1500 may further include learning an ordering of the importance of the one or more parameters in the decoder by using the training dataset; defining one or more ordering lists for indicating the ordering of the importance of the one or more parameters; sharing at least one ordering list of the one or more ordering lists with at least one of the encoder or the decoder; and sending or signaling at least one parameter of the one or more parameter that are updated by the model finetuning and at least one weight update corresponding to the at least one parameter to the decoder, wherein the decoder recovers the at least one weight update from the bitstream by using the received at least one parameter and the at least one ordering list.

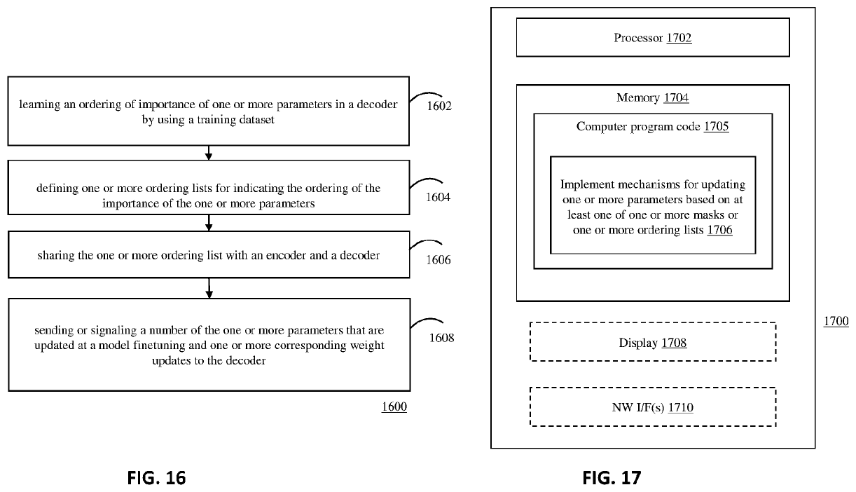

FIG. 16 illustrates an example method 1600 for defining one or more ordering lists, in accordance with an embodiment. As shown in block 1406 of FIG. 14, the apparatus 1400 includes means, such as the processing circuitry 1402 or the like, for implementing mechanisms for defining one or more ordering lists. At 1602, the method 1600 includes learning an ordering of importance of one or more parameters in a decoder by using a training dataset. At 1604, the method 1600 includes defining one or more ordering lists for indicating the ordering of the importance of the one or more parameters. At 1606, the method 1600 includes sharing the one or more ordering list with an encoder and a decoder. At 1608, the method 1600 includes sending or signaling a number of the one or more parameters that are updated at a model finetuning and one or more corresponding weight updates to the decoder.

In an embodiment, the decoder recovers the one or more weight updates from a bitstream by using the received number of the one or more parameters and the one or more importance weight ordering lists.

FIG. 17 is an example apparatus 1700, which may be implemented in hardware, configured to implement mechanisms for updating one or more parameters based on at least one of one or more masks or one or more ordering lists, in accordance with examples described herein. The apparatus 1700 comprises at least one processor 1702, at least one non-transitory memory 1704 including computer program code 1705, wherein the at least one memory 1704 and the computer program code 1705 are configured to, with the at least one processor 1702, cause the apparatus 1700 to implement mechanisms for updating the one or more parameters based on at least one of: one or more masks or one or more ordering lists 1706, in accordance with examples described herein. In an embodiment, the one or more parameters are associated with at least one neural network (NN) or a portion of the at least one NN. In an embodiment, the at least one neural network or the portion of the at least one neural network may be used at a decoder-side for decoding or reconstructing one or more media items.

The apparatus 1700 optionally includes a display 1708 that may be used to display content during rendering. The apparatus 1700 optionally includes one or more network (NW) interfaces (I/F(s)) 1710. The NW I/F(s) 1710 may be wired and/or wireless and communicate over the Internet/other network(s) via any communication technique. The NW I/F(s) 1710 may comprise one or more transmitters and one or more receivers. The N/W I/F(s) 1710 may comprise standard well-known components such as an amplifier, filter, frequency-converter, (de)modulator, and encoder/decoder circuitry(ies) and one or more antennas.

The apparatus 1700 may be a remote, virtual or cloud apparatus. The apparatus 1700 may be either a coder or a decoder, or both a coder and a decoder. The at least one memory 1704 may be implemented using any suitable data storage technology, such as semiconductor based memory devices, flash memory, magnetic memory devices and systems, optical memory devices and systems, fixed memory and removable memory. The at least one memory 1704 may comprise a database for storing data. The apparatus 1700 need not comprise each of the features mentioned, or may comprise other features as well. The apparatus 1700 may correspond to or be another embodiment of the apparatus 50 shown in FIG. 1 and FIG. 2, or any of the apparatuses shown in FIG. 3. The apparatus 1700 may correspond to or be another embodiment of the apparatuses shown in FIG. 19, including UE 110, RAN node 170, or network element(s) 190.

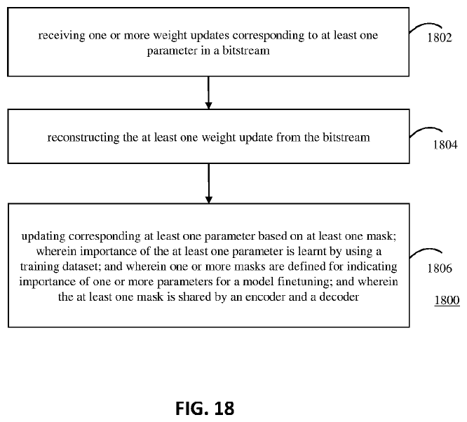

FIG. 18 illustrates an example method 1800 for defining one or more ordering lists, in accordance with an embodiment. As shown in block 1706 of FIG. 17, the apparatus 1700 includes means, such as the processing circuitry 1702 or the like, for implementing mechanisms for defining one or more ordering lists. At 1802, the method 1800 includes receiving one or more weight updates corresponding to at least one parameter in a bitstream. At 1804, the method 1800 includes reconstructing the at least one weight update from the bitstream. At 1806, the method 1800 includes updating corresponding at least one parameter based on at least one mask; wherein importance of the at least one parameter is learnt by using a training dataset; and wherein one or more masks are defined for indicating importance of one or more parameters for a model finetuning; and wherein the at least one mask is shared by an encoder and a decoder.

In an embodiment, the method 1800 may also include receiving a number of one or more parameters that are updated at the model finetuning and one or more corresponding weight updates; recovering one or more weight updates from a bitstream by using the received number of the one or more parameters and one or more ordering lists; wherein an ordering of importance of the one or more parameters in the decoder is learnt by using the training dataset; and wherein the one or more ordering lists indicate the ordering of the importance of the one or more parameters; and wherein the one or more ordering list is shared by the encoder and the decoder.

Referring to FIG. 19, this figure shows a block diagram of one possible and non-limiting example in which the examples may be practiced. A user equipment (UE) 110, radio access network (RAN) node 170, and network element(s) 190 are illustrated. In the example of FIG. 1, the user equipment (UE) 110 is in wireless communication with a wireless network 100. A UE is a wireless device that can access the wireless network 100. The UE 110 includes one or more processors 120, one or more memories 125, and one or more transceivers 130 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. The one or more transceivers 130 are connected to one or more antennas 128. The one or more memories 125 include computer program code 123. The UE 110 includes a module 140, comprising one of or both parts 140-1 and/or 140-2, which may be implemented in a number of ways. The module 140 may be implemented in hardware as module 140-1, such as being implemented as part of the one or more processors 120. The module 140-1 may be implemented also as an integrated circuit or through other hardware such as a programmable gate array. In another example, the module 140 may be implemented as module 140-2, which is implemented as computer program code 123 and is executed by the one or more processors 120. For instance, the one or more memories 125 and the computer program code 123 may be configured to, with the one or more processors 120, cause the user equipment 110 to perform one or more of the operations as described herein. The UE 110 communicates with RAN node 170 via a wireless link 111.

The RAN node 170 in this example is a base station that provides access by wireless devices such as the UE 110 to the wireless network 100. The RAN node 170 may be, for example, a base station for 5G, also called New Radio (NR). In 5G, the RAN node 170 may be a NG-RAN node, which is defined as either a gNB or an ng-eNB. A gNB is a node providing NR user plane and control plane protocol terminations towards the UE, and connected via the NG interface to a 5GC (such as, for example, the network element(s) 190). The ng-eNB is a node providing E-UTRA user plane and control plane protocol terminations towards the UE, and connected via the NG interface to the 5GC. The NG-RAN node may include multiple gNBs, which may also include a central unit (CU) (gNB-CU) 196 and distributed unit(s) (DUs) (gNB-DUs), of which DU 195 is shown. Note that the DU may include or be coupled to and control a radio unit (RU). The gNB-CU is a logical node hosting radio resource control (RRC), SDAP and PDCP protocols of the gNB or RRC and PDCP protocols of the en-gNB that controls the operation of one or more gNB-DUs. The gNB-CU terminates the F1 interface connected with the gNB-DU. The F1 interface is illustrated as reference 198, although reference 198 also illustrates a link between remote elements of the RAN node 170 and centralized elements of the RAN node 170, such as between the gNB-CU 196 and the gNB-DU 195. The gNB-DU is a logical node hosting RLC, MAC and PHY layers of the gNB or en-gNB, and its operation is partly controlled by gNB-CU. One gNB-CU supports one or multiple cells. One cell is supported by only one gNB-DU. The gNB-DU terminates the F1 interface 198 connected with the gNB-CU. Note that the DU 195 is considered to include the transceiver 160, for example, as part of a RU, but some examples of this may have the transceiver 160 as part of a separate RU, for example, under control of and connected to the DU 195. The RAN node 170 may also be an eNB (evolved NodeB) base station, for LTE (long term evolution), or any other suitable base station or node.

The RAN node 170 includes one or more processors 152, one or more memories 155, one or more network interfaces (N/W I/F(s)) 161, and one or more transceivers 160 interconnected through one or more buses 157. Each of the one or more transceivers 160 includes a receiver, Rx, 162 and a transmitter, Tx, 163. The one or more transceivers 160 are connected to one or more antennas 158. The one or more memories 155 include computer program code 153. The CU 196 may include the processor(s) 152, memories 155, and network interfaces 161. Note that the DU 195 may also include its own memory/memories and processor(s), and/or other hardware, but these are not shown.

The RAN node 170 includes a module 150, comprising one of or both parts 150-1 and/or 150-2, which may be implemented in a number of ways. The module 150 may be implemented in hardware as module 150-1, such as being implemented as part of the one or more processors 152. The module 150-1 may be implemented also as an integrated circuit or through other hardware such as a programmable gate array. In another example, the module 150 may be implemented as module 150-2, which is implemented as computer program code 153 and is executed by the one or more processors 152. For instance, the one or more memories 155 and the computer program code 153 are configured to, with the one or more processors 152, cause the RAN node 170 to perform one or more of the operations as described herein. Note that the functionality of the module 150 may be distributed, such as being distributed between the DU 195 and the CU 196, or be implemented solely in the DU 195.

The one or more network interfaces 161 communicate over a network such as via the links 176 and 131. Two or more gNBs 170 may communicate using, for example, link 176. The link 176 may be wired or wireless or both and may implement, for example, an Xn interface for 5G, an X2 interface for LTE, or other suitable interface for other standards.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195 for LTE or a distributed unit (DU) 195 for gNB implementation for 5G, with the other elements of the RAN node 170 possibly being physically in a different location from the RRH/DU, and the one or more buses 157 could be implemented in part as, for example, fiber optic cable or other suitable network connection to connect the other elements (for example, a central unit (CU), gNB-CU) of the RAN node 170 to the RRH/DU 195. Reference 198 also indicates those suitable network link(s).

It is noted that description herein indicates that ‘cells’ perform functions, but it should be clear that equipment which forms the cell may perform the functions. The cell makes up part of a base station. That is, there can be multiple cells per base station. For example, there could be three cells for a single carrier frequency and associated bandwidth, each cell covering one-third of a 360 degree area so that the single base station's coverage area covers an approximate oval or circle. Furthermore, each cell can correspond to a single carrier and a base station may use multiple carriers. So when there are three 120 degree cells per carrier and two carriers, then the base station has a total of 6 cells.

The wireless network 100 may include a network element or elements 190 that may include core network functionality, and which provides connectivity via a link or links 181 with a further network, such as a telephone network and/or a data communications network (for example, the Internet). Such core network functionality for 5G may include access and mobility management function(s) (AMF(S)) and/or user plane functions (UPF(s)) and/or session management function(s) (SMF(s)). Such core network functionality for LTE may include MME (Mobility Management Entity)/SGW (Serving Gateway) functionality. These are merely example functions that may be supported by the network element(s) 190, and note that both 5G and LTE functions might be supported. The RAN node 170 is coupled via a link 131 to the network element 190. The link 131 may be implemented as, for example, an NG interface for 5G, or an S1 interface for LTE, or other suitable interface for other standards. The network element 190 includes one or more processors 175, one or more memories 171, and one or more network interfaces (N/W I/F(s)) 180, interconnected through one or more buses 185. The one or more memories 171 include computer program code 173. The one or more memories 171 and the computer program code 173 are configured to, with the one or more processors 175, cause the network element 190 to perform one or more operations.

The wireless network 100 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors 152 or 175 and memories 155 and 171, and also such virtualized entities create technical effects.

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, fixed memory and removable memory. The computer readable memories 125, 155, and 171 may be means for performing storage functions. The processors 120, 152, and 175 may be of any type suitable to the local technical environment, and may include one or more of general purpose computers, special purpose computers, microprocessors, digital signal processors (DSPs) and processors based on a multi-core processor architecture, as non-limiting examples. The processors 120, 152, and 175 may be means for performing functions, such as controlling the UE 110, RAN node 170, network element(s) 190, and other functions as described herein.

In general, the various embodiments of the user equipment 110 can include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, as well as portable units or terminals that incorporate combinations of such functions.

One or more of modules 140-1, 140-2, 150-1, and 150-2 may be configured to implement mechanisms for defining at least one of one or more masks or one or more ordering lists; or implement mechanisms for updating one or more parameters based on at least one of one or more masks or one or more ordering lists. Computer program code 173 may also be configured to implement mechanisms for defining at least one of one or more masks or one or more ordering lists; or implement mechanisms for updating one or more parameters based on at least one of one or more masks or one or more ordering lists.

As described above, FIGS. 15, 16, and 18 include flowcharts of an apparatus (e.g., 50, 100, 604, 700, 1400, or 1700), method, and computer program product according to certain example embodiments. It will be understood that each block of the flowcharts, and combinations of blocks in the flowcharts, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory (e.g., 58, 125, 704, 1404, or 1704) of an apparatus employing an embodiment of the present invention and executed by processing circuitry (e.g., 56, 120, 702, 1402, or 1702) of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture, the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

A computer program product is therefore defined in those instances in which the computer program instructions, such as computer-readable program code portions, are stored by at least one non-transitory computer-readable storage medium with the computer program instructions, such as the computer-readable program code portions, being configured, upon execution, to perform the functions described above, such as in conjunction with the flowchart(s) of FIGS. 15, 16, and 18. In other embodiments, the computer program instructions, such as the computer-readable program code portions, need not be stored or otherwise embodied by a non-transitory computer-readable storage medium, but may, instead, be embodied by a transitory medium with the computer program instructions, such as the computer-readable program code portions, still being configured, upon execution, to perform the functions described above.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, may be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included. Modifications, additions, or amplifications to the operations above may be performed in any order and in any combination.

In the above, some example embodiments have been described with reference to an SEI message or an SEI NAL unit. It needs to be understood, however, that embodiments can be similarly realized with any similar structures or data units. Where example embodiments have been described with SEI messages contained in a structure, any independently parsable structures could likewise be used in embodiments. Specific SEI NAL unit and a SEI message syntax structures have been presented in example embodiments, but it needs to be understood that embodiments generally apply to any syntax structures with a similar intent as SEI NAL units and/or SEI messages.

In the above, some embodiments have been described in relation to a particular type of a parameter set (namely adaptation parameter set). It needs to be understood, however, that embodiments could be realized with any type of parameter set or other syntax structure in the bitstream.

In the above, some example embodiments have been described with the help of syntax of the bitstream. It needs to be understood, however, that the corresponding structure and/or computer program may reside at the encoder for generating the bitstream and/or at the decoder for decoding the bitstream.

In the above, where example embodiments have been described with reference to an encoder, it needs to be understood that the resulting bitstream and the decoder have corresponding elements in them. Likewise, where example embodiments have been described with reference to a decoder, it needs to be understood that the encoder has structure and/or computer program for generating the bitstream to be decoded by the decoder.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Accordingly, the description is intended to embrace all such alternatives, modifications and variances which fall within the scope of the appended claims. Although specific terms are employed herein, they are used in a generic and descriptive sense only and not for purposes of limitation.

It should be understood that the foregoing description is only illustrative. Various alternatives and modifications may be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modifications and variances which fall within the scope of the appended claims.

References to a ‘computer’, ‘processor’, etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device such as instructions for a processor, or configuration settings for a fixed-function device, gate array or programmable logic device, and the like.

As used herein, the term ‘circuitry’ may refer to any of the following: (a) hardware circuit implementations, such as implementations in analog and/or digital circuitry, and (b) combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even when the software or firmware is not physically present. This description of ‘circuitry’ applies to uses of this term in this application. As a further example, as used herein, the term ‘circuitry’ would also cover an implementation of merely a processor (or multiple processors) or a portion of a processor and its (or their) accompanying software and/or firmware. The term ‘circuitry’ would also cover, for example, and when applicable to the particular element, a baseband integrated circuit or applications processor integrated circuit for a mobile phone or a similar integrated circuit in a server, a cellular network device, or another network device.

1-38. (canceled)

39. An apparatus comprising at least one processor; and at least one non-transitory memory comprising computer program code; wherein the at least one non-transitory memory and the computer program code are configured to, with the at least one processor, cause the apparatus at least to perform:
learn importance of one or more parameters by using a training dataset;
define one or more masks for indicating an importance of the one or more parameters for a model finetuning;
share at least one mask of the one or more masks with at least one of an encoder or a decoder;
finetune at least one parameter of the one or more parameters based at least on the at least one mask; and
send or signal one or more weight updates corresponding to the at least one parameter in a bitstream to the decoder.

40. The apparatus of claim 39, wherein the apparatus is further caused to:
learn an ordering of the importance of the one or more parameters in the decoder by using the training dataset;
define one or more ordering lists for indicating the ordering of the importance of the one or more parameters;
share at least one ordering list of the one or more ordering lists with at least one of the encoder or the decoder; and
send or signal at least one parameter of the one or more parameters that are updated by the model finetuning and at least one weight update corresponding to the at least one parameter to the decoder, wherein the decoder recovers the at least one weight update from the bitstream by using the received at least one parameter and the at least one ordering list.

41. The apparatus of claim 40, wherein the apparatus is further caused to determine at least one of:
the at least one mask of the one or more masks to be used by the encoder during the model finetuning; or
at least one ordering list of the one or more ordering lists to be used by the encoder during a model finetuning stage.

42. The apparatus of claim 40, wherein to learn the importance of the one or more parameters or to learn an ordering of the importance of the one or more parameters, the apparatus is further caused to:
minimize an objective function with a suitable loss term;
determine one or more importance scores for each parameter based on a minimized objective function; and
determine at least one of:
the at least one mask by using the one or more importance scores and a threshold value; or
the at least one ordering list by sorting the one or more parameters based on the one or more importance scores of the each one or more parameters.

43. The apparatus of claim 42, wherein the one or more importance scores for the each parameter comprises one of:
a sum of an absolute value of the weight update value of the each parameter for samples in the training dataset;
a sum of an absolute value of a ratio of the weight update value over an original weight value on the each parameter for samples in the training dataset; or
a combination of an importance metric and a learned importance, wherein the combination is using a summation or multiplication of scores of the one or more parameters; or
a non-linear combination of the importance metric and the learned importance, wherein the non-linear combination is determined using a learning based approach.

44. The apparatus of claim 40, wherein the apparatus is further caused to identify an optimal number of the one or more parameters and the corresponding weight updates, and wherein to identify the optimal number of the one or more parameters and the corresponding weight updates, the apparatus is further caused to:
perform a first model finetuning by selecting a first set of important parameters based on the one or more ordering lists;
save the first finetuned model to achieve a first saved finetuned model;
calculate a first rate distortion (RD) loss value including weight update overheads; and
repeat following until a stopping criterion is met:
remove a predetermined number of important parameters from the first set of important parameters;
continue the model finetuning from the first saved finetuned model to achieve a second finetuned model;
save the second finetuned model; and
calculate a second RD loss value including the weight update overheads.

45. The apparatus of claim 39, wherein the apparatus is further caused to:
determine an optimal mask of the one or more masks;
determine optimal weight updates corresponding to the optimal mask at a model finetuning stage; and
send or signal an index of the optimal mask and the optimal weight updates corresponding to the optimal mask to the decoder, wherein the decoder reconstructs the index of the optimal mask and the optimal weight updates from the bitstream and updates the parameters corresponding to the optimal weight updates in a model according to the optimal mask.

46. The apparatus of claim 40, wherein the apparatus is further caused to:
determine an optimal ordering list from the one or more ordering lists;
determine an optimal number of parameters from the one or more parameters;
determine an optimal number of weight updates corresponding to the optimal parameters at a model finetuning stage; and
send or signal an index of the optimal ordering list, the optimal number of parameters, and the optimal weight updates to the decoder, wherein the decoder reconstructs the index of the optimal ordering list, the optimal number of parameters, and the optimal weight updates from the bitstream, and updates the parameters corresponding to the optimal weight updates in a model according to the optimal ordering list and the optimal number of parameters.

47. The apparatus of claim 40, wherein the apparatus is further caused to:
learn the one or more masks or the one or more ordering lists from an input content; and
signal the learned one or more masks or ordering lists to the decoder.

48. The apparatus of claim 40, wherein to share the at least one mask and the at least one ordering list, the apparatus is further caused to perform one or more of:
define at least one of the one or more masks or the one or more ordering lists;
define a unique identifier for each mask or each ordering list, and indicate unique identifiers of the each mask or the each ordering list in or along the bitstream from the encoder to the decoder;
deliver the at least one of the at least one mask or the at least one ordering list in or along the bitstream;
deliver the at least one of the at least one mask or the at least one ordering list; or
deliver the at least one of the at least one mask or the at least one ordering list from the encoder to the decoder prior to or during delivery of the bitstream.

49. The apparatus of claim 40, wherein the apparatus is further caused to:
select a first number of parameters to be updated for a first unit of the bitstream;
indicate the first number of parameters and the updated first number of parameters associated with the first unit of the bitstream;
use an updated neural network for encoding the first unit of the bitstream;
select a second number of parameters to be updated for a second unit of the bitstream, wherein the second unit follows the first unit in a bitstream order, and the second number of parameters follow the first number of parameters in the at least one ordering list;
indicate the second number of parameters and the updated second number of parameters associated with the second unit of the bitstream; and
use the updated neural network for encoding the second unit of the bitstream.

50. The apparatus of claim 49, wherein the apparatus is further caused to select at least one of the first number of parameters or the second number of parameters according to one or more of the following:
a bit budget for the updated first number of parameters or the updated second number of parameters; or
a rate-distortion decision performed for the first unit and the first number of parameters separately from the second unit and the second number of parameters, wherein the first unit and the second unit may are selected to be a first coded picture and a second coded picture respectively, or a first hierarchical prediction structure of pictures and a second hierarchical prediction structure of the pictures.

51. The apparatus of claim 50, wherein the bit budget is determined based on one or more of the following:
a leftover bitrate in a previous unit the bitstream; or
a leftover size in video packets; wherein in a packet-oriented networks one or more packets up to a maximum transfer unit (MTU) size are treated equally, and wherein the bit budget is be determined to fill in a packet up to an MTU size in an instance a unit of the bitstream carried in the packet has size less than the MTU size.

52. The apparatus of claim 49, wherein the apparatus is further caused to determine and indicate in or along the bitstream:
whether the second number of parameters follow the first number of parameters in the at least one ordering list; or
whether the second number of parameters are related to a start of the at least one ordering list;
wherein the decoder decodes associated weight updates according to an indicated position in the at least one ordering list.

53. An apparatus comprising at least one processor; and at least one non-transitory memory comprising computer program code; wherein the at least one non-transitory memory and the computer program code are configured to, with the at least one processor, cause the apparatus at least to perform:
receive one or more weight updates corresponding to at least one parameter in a bitstream;
reconstruct at least one weight update from the bitstream; and
update corresponding at least one parameter based on at least one mask;
wherein importance of the at least one parameter is learnt by using a training dataset; and wherein one or more masks are defined for indicating importance of one or more parameters for a model finetuning; and wherein the at least one mask is shared by an encoder and a decoder.

54. The apparatus of claim 53, wherein the apparatus is further caused to:
receive a number of one or more parameters that are updated at the model finetuning and one or more corresponding weight updates; and
recover the one or more weight updates from the bitstream by using the received number of the one or more parameters and one or more ordering lists;
wherein an ordering of importance of the one or more parameters in the decoder is learnt by using the training dataset; and wherein the one or more ordering lists indicate the ordering of the importance of the one or more parameters; and wherein the one or more ordering list is shared by the encoder and the decoder.

55. The apparatus of claim 53, wherein the apparatus is further caused to:
reconstruct a first number of parameters and a respective first number of weight updates from the bitstream;
update a corresponding first number of parameters in a model according to the one or more ordering list;
use an updated neural network for decoding a first unit of the bitstream;
reconstruct a second number of parameters and a respective second number of weight updates from the bitstream, wherein a second unit follows the first unit in a bitstream order, and the second number of parameters follow the first number of parameters in an importance ordering list;
update corresponding second number parameters in the model according to the one or more ordering list; and
use the updated neural network for decoding the second unit of the bitstream.

56. A method comprising:
receiving one or more weight updates corresponding to at least one parameter in a bitstream;
reconstructing at least one weight update from the bitstream; and
updating corresponding at least one parameter based on at least one mask;
wherein importance of the at least one parameter is learnt by using a training dataset; and wherein one or more masks are defined for indicating importance of one or more parameters for a model finetuning; and wherein the at least one mask is shared by an encoder and a decoder.

57. The method of claim 56 further comprising:
receiving a number of one or more parameters that are updated at the model finetuning and one or more corresponding weight updates; and
recovering one or more weight updates from the bitstream by using the received number of the one or more parameters and one or more ordering lists;
wherein an ordering of importance of the one or more parameters in the decoder is learnt by using the training dataset; and wherein the one or more ordering lists indicate the ordering of the importance of the one or more parameters; and wherein the one or more ordering lists is shared by the encoder and the decoder.

58. A method comprising:
learning an ordering of importance of one or more parameters in a decoder by using a training dataset;
defining one or more ordering lists for indicating the ordering of an importance of the one or more parameters;
sharing the one or more ordering lists with an encoder and a decoder; and
sending or signaling a number of the one or more parameters that are updated at a model finetuning and one or more corresponding weight updates to the decoder.
